(19) United States
(12) Patent Application Publication
(10) Pub. No.: US 2026/0361778 A1
(43) Pub. Date: Nov. 12, 2026

(54) INTERACTION METHODS AND APPARATUSES, ELECTRONIC DEVICE, AND STORAGE MEDIUM

(71) Applicant: Beijing Zitiao Network Technology Co., Ltd., Beijing (CN)

(72) Inventors: Yueying WANG, Beijing (CN); Bowen SHEN, Beijing (CN); Zhaoyuan PENG, Beijing (CN); Jian SUN, Beijing (CN); Xin XIE, Singapore (SG)

(21) Appl. No.: 19/121,734

(22) PCT Filed: Oct. 18, 2023
(86) PCT No.: PCT/CN2023/125240

§ 371 Date: Apr. 16, 2025

(30) Foreign Application Priority Data
Oct. 19, 2022 (CN) 202211282085.8
Oct. 19, 2022 (CN) 202211282111.7

(51) Int. Cl. H04L 65/1093; H04L 9/40

(52) U.S. Cl. CPC H04L 65/1093; H04L 63/102

(57) ABSTRACT

An interaction method, an electronic device, and a storage medium are provided. The method includes: obtaining a first change request for changing an association relationship between a first object set and a second object set, a member of the first object set being allowed to include an individual member and a set member, a member of the second object set including an individual member, the individual member being one member object, and the set member being a member object set; and in response to the first change request: establishing a first association relationship between the second object set and the first object set, and adding the second object set as the set member to the first object set, or releasing the first association relationship between the second object set and the first object set, and removing the second object set as the set member from the first object set.

This application claims the priority to Chinese Patent Application No. 202211282111.7, filed on Oct. 19, 2022, and Chinese Patent Application No. 202211282085.8, filed on Oct. 19, 2022, the entire disclosure of which is incorporated herein by reference as part of the disclosure of this application.

### TECHNICAL FIELD

Embodiments of the present disclosure relate to an interaction method, an interaction apparatus, an electronic device, and a storage medium.

### BACKGROUND

Internet communication technologies provide a variety of communication systems, such as online document communication, instant messaging (IM), or the like. The instant messaging system is a real-time communication system that enables users to exchange various types of data information, such as text messages, voice messages, files, or the like, in real time based on the instant messaging session through the network, and can also support real-time voice communication, video communication or the like between the users. At present, various communication system technologies such as instant messaging have been widely applied to different scenarios or different fields, such as collaborative office, teaching, entertainment, or the like. In particular, online collaborative office systems based on Internet communication technologies have also attracted more and more attention. These online collaborative office systems integrate applications such as instant messaging, online documents, audio and video conferences, calendars, or the like, so that the collaborative working efficiency of users in an organization (such as an enterprise, a school, a group, or the like) can be improved.

### SUMMARY

At least one embodiment of the present disclosure provides an interaction method, and the interaction method includes: obtaining a first change request for changing an association relationship between a first object set and a second object set, a member of the first object set being allowed to comprise an individual member and a set member, a member of the second object set comprising an individual member, the individual member being one member object, and the set member being a member object set comprising at least one member object; and in response to the first change request: establishing a first association relationship between the second object set and the first object set, and adding the second object set as the set member to the first object set, or releasing the first association relationship between the second object set and the first object set, and removing the second object set as the set member from the first object set.

At least one embodiment of the present disclosure further provides an interaction apparatus, and the interaction apparatus includes an association relationship change request obtaining unit, an association relationship establishing unit, and an association relationship release unit; the association relationship change request obtaining unit is configured to obtain a first change request for changing an association relationship between a first object set and a second object set, a member of the first object set is allowed to comprise an individual member and a set member, a member of the second object set comprises an individual member, the individual member is one member object, and the set member is a member object set comprising at least one member object; the association relationship establishing unit is configured to establish, in response to the first change request, a first association relationship between the second object set and the first object set, and add the second object set as the set member to the first object set; and the association relationship release unit is configured to release, in response to the first change request, the first association relationship between the second object set and the first object set, and remove the second object set as the set member from the first object set.

At least one embodiment of the present disclosure further provides an interaction method, and the interaction method includes: obtaining a first trigger operation for a first object set, a member of the first object set comprising an individual member and a set member, the individual member being a single member object, and the set member being a member object set comprising at least one member object; and in response to the first trigger operation, presenting individual member information and set member information of the first object set.

At least one embodiment of the present disclosure further provides an interaction apparatus, and the interaction apparatus includes a trigger operation obtaining unit and an information presentation unit; the trigger operation obtaining unit is configured to obtain a first trigger operation for a first object set, a member of the first object set comprises an individual member and a set member, the individual member is a single member object, and the set member is a member object set comprising at least one member object; and the information presentation unit is configured to present, in response to the first trigger operation, individual member information and set member information of the first object set.

At least one embodiment of the present disclosure further provides an interaction method, and the interaction method includes: obtaining a relationship release request for releasing an association relationship between a first object set and a second object set, a member of the first object set being allowed to comprise an individual member and a set member, a member of the second object set comprising an individual member, the individual member being one member object, the set member being a member object set comprising at least one member object, and the second object set being the set member of the first object set; and in response to the relationship release request, releasing the association relationship between the second object set and the first object set, and removing the second object set as the set member from the first object set.

At least one embodiment of the present disclosure further provides an interaction apparatus, and the interaction apparatus includes an association relationship release request obtaining unit and an association relationship release unit; the association relationship release request obtaining unit is configured to obtain a relationship release request for releasing an association relationship between a first object set and a second object set, a member of the first object set is allowed to comprise an individual member and a set member, a member of the second object set comprises an individual member, the individual member is one member object, the set member is a member object set comprising at least one member object, and the second object set is the set member of the first object set; and the association relationship release unit is configured to, in response to the relationship release request, release the association relationship between the second object set and the first object set, and remove the second object set as the set member from the first object set.

At least one embodiment of the present disclosure further provides an interaction method, and the interaction method includes: obtaining a first member adding request or a second member adding request for adding a user to a first object set, an association relationship being present between the first object set and a second object set, and the second member adding request being a request for adding the user to the first object set through the second object set when the user is a member object of the second object set; and in response to the first member adding request, adding the user to the first object set to enable the user to become a member object of the first object set, and granting a first member identity attribute to the user in the first object set, or in response to the second member adding request, adding the user to the first object set through the second object set, to enable the user to become a member object of the first object set, and granting a second member identity attribute to the user in the first object set, the second member identity attribute being associated with the second object set.

At least one embodiment of the present disclosure further provides an interaction apparatus, and the interaction apparatus includes a member adding request obtaining unit and a member adding request response unit; the member adding request obtaining unit is configured to obtain a first member adding request or a second member adding request for adding a user to a first object set, an association relationship is present between the first object set and a second object set, and the second member adding request is a request for adding the user to the first object set through the second object set when the user is a member object of the second object set; and the member adding request response unit is configured to: in response to the first member adding request, add the user to the first object set to enable the user to become a member object of the first object set, and grant a first member identity attribute to the user in the first object set, or in response to the second member adding request, add the user to the first object set through the second object set, to enable the user to become a member object of the first object set, and grant a second member identity attribute to the user in the first object set, the second member identity attribute being associated with the second object set.

At least one embodiment of the present disclosure further provides an interaction method, and the interaction method includes: obtaining a trigger operation for a first object set, an association relationship being present between the first object set and a second object set, a member object of the first object set having a first member identity attribute and/or a second member identity attribute, and the first member identity attribute being different from the second member identity attribute; and in response to the trigger operation, presenting member identity attribute information of the member object of the first object set.

At least one embodiment of the present disclosure further provides an interaction apparatus, and the interaction apparatus includes a trigger operation obtaining unit and a member identity attribute information presentation unit; the trigger operation obtaining unit is configured to obtain a trigger operation for a first object set, an association relationship is present between the first object set and a second object set, a member object of the first object set has a first member identity attribute and/or a second member identity attribute, and the first member identity attribute is different from the second member identity attribute; and the member identity attribute information presentation unit is configured to, in response to the trigger operation, present member identity attribute information of the member object of the first object set.

At least one embodiment of the present disclosure further provides an electronic device, and the electronic device includes a processor and a memory; the memory includes one or more computer-executable instructions; the one or more computer-executable instructions are stored in the memory and configured to be executed by the processor; and the one or more computer-executable instructions are configured to implement the interaction method according to any one of the embodiments of the present disclosure.

At least one embodiment of the present disclosure further provides a storage medium, the storage medium is configured to store non-transitory computer-executable instructions, and the non-transitory computer-executable instructions, when executed by a processor, cause the processor to implement the interaction method according to any one of the embodiments of the present disclosure.

### BRIEF DESCRIPTION OF DRAWINGS

In order to more clearly explain the technical solutions of the embodiments of the present disclosure, the accompanying drawings of the embodiments will be briefly described below. It is obvious that the accompanying drawings in the following description only relate to some embodiments of the present disclosure, rather than limiting the present disclosure.

FIG. 1 shows a system that can be used to implement interaction methods provided by the embodiments of the present disclosure;

FIG. 2 is a schematic flowchart of an interaction method provided by some embodiments of the present disclosure;

FIG. 3 is a schematic diagram of an application example based on a first object set provided by some embodiments of the present disclosure;

FIG. 4 is a schematic diagram of another application example based on a first object set provided by some embodiments of the present disclosure;

FIG. 5 is a schematic diagram of still another application example based on a first object set provided by some embodiments of the present disclosure;

FIG. 6 is a schematic diagram of still another application example based on a first object set provided by some embodiments of the present disclosure;

FIG. 7 is a schematic flowchart of a specific example of an interaction method provided by some embodiments of the present disclosure;

FIG. 8 is a schematic flowchart of another specific example of an interaction method provided by some embodiments of the present disclosure;

FIG. 9 is a schematic flowchart of another interaction method provided by some embodiments of the present disclosure;

FIG. 10 is a schematic flowchart of still another interaction method provided by some embodiments of the present disclosure;

FIG. 11 is a schematic flowchart of still another interaction method provided by some embodiments of the present disclosure;

FIG. 12 is a schematic diagram of still another application example based on a first object set provided by some embodiments of the present disclosure;

FIG. 13 is a schematic diagram of still another application example based on a first object set provided by some embodiments of the present disclosure;

FIG. 14 is a schematic diagram of still another application example based on a first object set provided by some embodiments of the present disclosure;

FIG. 15 is a schematic diagram of still another application example based on a first object set provided by some embodiments of the present disclosure;

FIG. 16 is a schematic diagram of still another application example based on a first object set provided by some embodiments of the present disclosure;

FIG. 17 is a schematic diagram of still another application example based on a first object set provided by some embodiments of the present disclosure;

FIG. 18 is a schematic flowchart of still another interaction method provided by some embodiments of the present disclosure;

FIG. 19 is a schematic block diagram of an interaction apparatus provided by some embodiments of the present disclosure;

FIG. 20 is a schematic block diagram of another interaction apparatus provided by some embodiments of the present disclosure;

FIG. 21 is a schematic block diagram of still another interaction apparatus provided by some embodiments of the present disclosure;

FIG. 22 is a schematic block diagram of still another interaction apparatus provided by some embodiments of the present disclosure;

FIG. 23 is a schematic block diagram of still another interaction apparatus provided by some embodiments of the present disclosure;

FIG. 24 is a schematic block diagram of an electronic device provided by some embodiments of the present disclosure;

FIG. 25 is a schematic block diagram of another electronic device provided by some embodiments of the present disclosure; and

FIG. 26 is a schematic diagram of a storage medium provided by some embodiments of the present disclosure.

### DETAILED DESCRIPTION

Embodiments of the present disclosure will be described in more detail below with reference to the accompanying drawings. Although some embodiments of the present disclosure are shown in the accompanying drawings, it should be understood that the present disclosure may be implemented in various forms and should not be construed as being limited to the embodiments set forth herein. On the contrary, these embodiments are provided for a more thorough and complete understanding of the present disclosure. It should be understood that the accompanying drawings and the embodiments of the present disclosure are only for illustrative purposes, and are not intended to limit the scope of protection of the present disclosure.

The term “and/or” used herein means “and” or “or,” that is, it can be either “and” or “or.” For example, “A and/or B” represents three parallel cases: namely, a case of “including A but not including B,” a case of “including B but not including A,” and a case of “including both A and B.”

It should be understood that the various steps described in the method implementations of the present disclosure may be performed in different orders, and/or performed in parallel. In addition, additional steps may be included and/or the execution of the illustrated steps may be omitted in the method implementations. The scope of the present disclosure is not limited in this respect.

The term “include/comprise” used herein and the variations thereof are an open-ended inclusion, that is, “include/comprise but are not limited to.” The term “based on” is “at least partially based on.” The term “an embodiment” means “at least one embodiment.” The term “another embodiment” means “at least one another embodiment.” The term “some embodiments” means “at least some embodiments.” The relevant definitions of other terms will be given in the description below.

It should be noted that concepts such as “first” and “second” mentioned in the present disclosure are only used to distinguish different apparatuses, modules, or units, and are not used to limit an order or interdependence of functions performed by these apparatuses, modules, or units.

It should be noted that the modifiers “one” and “a plurality of” mentioned in the present disclosure are illustrative rather than restrictive, and those skilled in the art should understand that unless the context clearly indicates otherwise, it should be understood as “one or more.”

Names of messages or information exchanged between apparatuses in the implementations of the present disclosure are only for illustrative purposes, and are not used to limit the scope of these messages or information.

Taking an instant messaging system as an example, when a user exchanges information using instant messaging technology, for example, the user sends such as text or voice information through instant messaging software, the user may send information to a certain user separately through a one-to-one chat session, or the user may also join a group and exchange information with other group members in the group. Moreover, according to actual needs, the group may also be associated with another group or an organizational structure, so that the user can understand or grasp the required information in a timely and effective manner through more information access channels.

At least one embodiment of the present disclosure provides an interaction method, and the interaction method includes: obtaining a first change request for changing an association relationship between a first object set and a second object set, a member of the first object set being allowed to include an individual member and a set member, a member of the second object set including an individual member, the individual member being one member object, and the set member being a member object set including at least one member object; and in response to the first change request: establishing a first association relationship between the second object set and the first object set, and adding the second object set as the set member to the first object set, or releasing the first association relationship between the second object set and the first object set, and removing the second object set as the set member from the first object set.

In at least one example of the interaction method provided by the above embodiment of the present disclosure, when the first object set has the association relationship with the second object set, the second object set serves as one set member of the first object set. Therefore, when the association relationship between the first object set and the second object set changes, it may help to implement quick batch change processing on the member objects in the first object set, thereby facilitating implementing flexible management of the member objects in the first object set.

For example, in some embodiments of the present disclosure, the first object set and the second object set may refer to a set including a plurality of member objects, or the first object set and the second object set may also refer to a data entity or a data object that organizes a plurality of member objects for implementing certain functions or certain operations, or the first object set and the second object set may also refer to a data entity or a data object that organizes a plurality of member objects to provide certain functions for the plurality of member objects or allow the plurality of member objects to perform certain operations.

For example, the first object set or the second object set may organize the member objects such that the member objects can implement data or information exchange or provide services such as data or information exchange under the first object set or the second object set. For example, the member objects may directly exchange data or information in the form of the first object set or the second object set, or directly provide services such as data or information exchange functions in the form of the first object set or the second object set. For example, the first object set or the second object set may be a group or a discussion group including a plurality of users.

For another example, an interaction mode such as a platform or a channel for data or information exchange of the member objects may also be provided under the first object set, so that the member objects of the first object set can exchange data or information under the overall organizational structure of the first object set. For example, the member objects can exchange data or information through the second object set associated with the first object set, so that the first object set indirectly has an effect or function of providing information exchange. For example, the first object set may be a user set including a plurality of users, and a group or a discussion group may be set under the first object set, so that the users can exchange information through the group or the discussion group.

The embodiments of the present disclosure will be described in detail below with reference to the accompanying drawings. It should be noted that the same reference numerals in different accompanying drawings will be used to refer to the same elements that have been described.

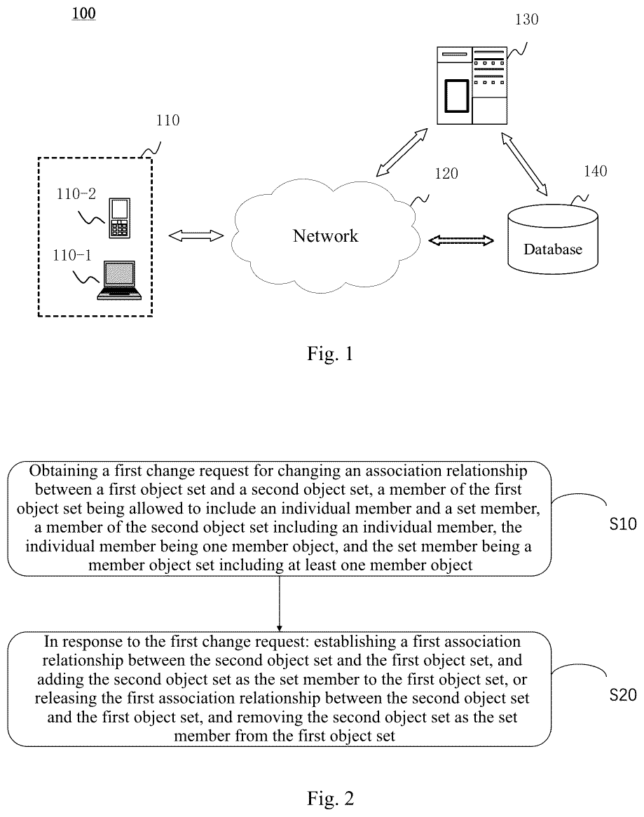

FIG. 1 shows a system that can be used to implement interaction methods provided by the embodiments of the present disclosure. As shown in FIG. 1, the system 100 may include a user terminal 110, a network 120, a server 130, and a database 140. For example, the system 100 may be used to implement the interaction method according to any one of the embodiments of the present disclosure.

The user terminal 110 is, for example, a computer 110-1 or a mobile phone 110-2. It can be understood that the user terminal 110 may be any other type of electronic device capable of performing data processing, and may include but is not limited to a desktop computer, a notebook computer, a tablet computer, a smart phone, a smart home device, a wearable device, an in-vehicle electronic device, a monitoring device, or the like. The user terminal 110 may also be any equipment provided with an electronic device, such as a vehicle, a robot, or the like.

A user may operate an application installed on the user terminal 110, the application transmits user behavior data to the server 130 through the network 120, and the user terminal 110 may further receive data transmitted by the server 130 through the network 120.

For example, the application on the user terminal 110 may be a collaborative office application, or may be a social application or the like. For example, the collaborative office application may refer to an application that uses technologies such as the network and the computer to implement functions of information communication, sharing, collaboration or the like between users to meet the requirements of the users for working together. For example, the social application may refer to an application for sending and receiving messages or instant messaging based on a social relationship link between users.

For example, in the above application, the user may send a message to a contact, or may receive a message sent by the contact. The contact may be a single user, or may be a group. For example, a group refers to a cluster including at least two users, and the group may also be referred to as a contact group, a group chat, a discussion group, or the like.

The user terminal 110 may implement the interaction method provided by the embodiments of the present disclosure by running a program (process) or a thread. In some examples, the user terminal 110 may execute the interaction method by using a built-in application. In some other examples, the user terminal 110 may execute the interaction method by calling an application stored outside the user terminal 110.

The network 120 may be a single network, or a combination of at least two same networks or different networks. For example, the network 120 may include but is not limited to one or a combination of several of a local area network, a wide area network, a public network, a dedicated network, or the like.

The server 130 may be a single server, a server group, a cloud server, or the like. For example, servers in the server group are connected through a wired or wireless network. The server group may be centralized, such as a data center, or may be distributed. The server 130 may be local or remote. The server 130 may communicate with the user terminal 110 through a wired or wireless network.

The database 140 may generally refer to a device having a data storage function, and for example, may further provide a data processing (for example, retrieval, sorting, or the like) function. The database 140 is mainly used to store various data used, generated, and output by the user terminal 110 and the server 130 during work, and for example, may include a plurality of sub-databases. The database 140 may be local or remote. The embodiments of the present disclosure do not limit the type of the database, which may be, for example, a relational database or a non-relational database. The database 140 may include various memories, for example, a random access memory (RAM), a read-only memory (ROM), or the like. The storage devices mentioned above are only some examples, and the storage devices that can be used by the system 100 are not limited thereto.

The database 140 may be connected to or communicate with the server 130 or a part thereof through the network 120, or may be directly connected to or communicate with the server 130, or may be connected to or communicate with the server 130 by a combination of the above two methods.

In some examples, the database 140 may be an independent device. In some other examples, the database 140 may also be integrated in at least one of the user terminal 110 and the server 130. For example, the database 140 may be disposed on the user terminal 110, or may be disposed on the server 130. For another example, the database 140 may also be distributed, and a part thereof is disposed on the user terminal 110, and another part thereof is disposed on the server 130.

FIG. 2 is a schematic flowchart of an interaction method provided by some embodiments of the present disclosure. The interaction method may be applied to the server 130 in the system 100 shown in FIG. 1, or may be applied to the user terminal 110 in the system 100 shown in FIG. 1, or may be applied to both the server 130 and the user terminal 110. For example, a user such as a person may access the server 130 through the user terminal 110, and perform an operation through an operation interface provided by a client software on the user terminal 110, for example, in a collaborative office application or a social application that is applied to the user terminal 110.

As shown in FIG. 2, the interaction method provided by the embodiments of the present disclosure includes Step S10 and Step S20.

Step S10: obtaining a first change request for changing an association relationship between a first object set and a second object set, a member of the first object set being allowed to include an individual member and a set member, a member of the second object set including an individual member, the individual member being one member object, and the set member being a member object set including at least one member object.

Step S20: in response to the first change request: establishing a first association relationship between the second object set and the first object set, and adding the second object set as the set member to the first object set, or releasing the first association relationship between the second object set and the first object set, and removing the second object set as the set member from the first object set.

For example, for Step S10 described above, the first object set may be a set including one or more members, and the member may be an individual member composed of a single member object, or the member may be a member object set (for example, a group of member objects) composed of one or more member objects, that is, a set member.

For example, each member object in the first object set may be a user. For example, taking the interaction method provided in the embodiments of the present disclosure being applied to a collaborative office application as an example, the user may refer to a real person or entity that uses a related device or network service, that is, a real user; or the user may also refer to a computer program, such as a chat robot or a service assistant, which is set in the system and can simulate human conversation to provide services.

For example, the second object set may be a set including one or more members, and the member may be an individual member composed of a single member object, that is, the second object set may be a set including one or more member objects. For example, the one or more member objects may be various types of member objects belonging to the object set, which are with different attributes, with different functions, or for different operations. For example, the member object of the second object set may be a user. For example, taking the interaction method provided in the embodiments of the present disclosure being applied to a collaborative office application as an example, the user may refer to a real person or entity that uses a related device or network service, that is, a real user; or the user may also refer to a computer program, such as a chat robot or a service assistant, which is set in the system and can simulate human conversation to provide services.

For example, in some examples, object types of member objects of the first object set may be the same as or different from each other, and object types of member objects of the second object set may be the same as or different from each other. For example, each member object in the first object set and the second object set may be a real person or entity that uses the related device or network service, or the member objects in the first object set and the second object set may include both a real user and a computer program such as a chat robot or a service assistant that provides a service.

Some embodiments of the present disclosure do not specifically limit the types, attributes, and functions of the member objects of the first object set and the member objects of the second object set.

For example, the first object set and the second object set may further include controls for serving users, such as functional controls such as a collaborative document, a calendar, or an audio and video conference, or container controls for storing related interaction information. For example, a control refers to an encapsulation of data and a method, and the control may serve a user, so that the user implements different interaction operations through the control or the control provides different interaction functions, information storage functions, or the like for the user.

For example, the first object set organizes the member objects such that the member objects can exchange data or information under the first object set. For example, the member objects may directly exchange data or information in the form of the first object set, for example, the first object set may be a group or a discussion group including multiple users; or other interaction forms such as a platform or a channel for data or information exchange of the member objects may also be provided under the first object set, so that the member objects can exchange data or information under the overall organizational structure of the first object set. For example, the first object set may be a user set including one or more (and/or one group or multiple groups of) users, and a group or a discussion group may be set under the first object set, so that the users can exchange information through the group or the discussion group.

For example, the second object set may be a platform or a channel serving users that is used to enable data or information exchange between member objects of the second object set, so that the member objects of the second object set can directly exchange data or information in the form of the second object set. For example, the second object set may be a chat group including multiple users as member objects, so that the users can exchange information such as the text, picture, voice, video, or network link in the chat group.

For another example, in addition to the user, the second object set may also include functional controls such as a document, a calendar, or an audio and video conference, or container controls for storing interaction information, to provide the above information exchange mode based on the functional controls such as the document, the calendar, or the audio and video conference, or to provide the interaction information storage function. For example, when the second object set has an association relationship with the first object set, the member object of the first object set may access, for example, the document, the calendar, the audio and video conference, or the like in the second object set and perform a corresponding operation, so that the member object in the first object set can exchange different types of information or perform different operations in the form of the second object set.

For example, information transmission or information exchange in the first object set and the second object set may include any one of the following operations for a specific or non-specific member object: sending or receiving text information, sending or receiving voice information, sending or receiving video information, sending or receiving picture information, sending or receiving network link information, or the like. The network link information may be, for example, a link to various appropriate network resources, such as the web page, audio, video, dynamic picture, executable code, or the like, and the executable code may be, for example, a mini program, a script (such as JavaScript, etc.) or the like, to implement a corresponding function.

It should be noted that the information exchange that can be implemented in the form of the first object set or the second object set includes but is not limited to the foregoing cases, and some embodiments of the present disclosure do not specifically limit the types or modes of information exchange that can be implemented by the first object set and the second object set. For example, information that can be sent by an operation may be information that is concerned by all member objects, or the information sent by the operation may be information that requires a specific object to pay attention to.

Some embodiments of the present disclosure do not specifically limit the specific form, function, or type of the first object set and the second object set.

For example, the first object set may have an association relationship with the second object set. For example, the association relationship may be a reference relationship, for example, the first object set references the second object set, or the second object set references the first object set. For example, the association relationship may be a subordination relationship, for example, the first object set is subordinate to the second object set, or the second object set is subordinate to the first object set. Some embodiments of the present disclosure do not specifically limit this.

For example, in some embodiments of the present disclosure, the first association relationship in Step S20 described above may be a reference relationship, for example, the first object set references the second object set. Alternatively, in some embodiments of the present disclosure, the first association relationship in Step S20 may also be a subordination relationship, for example, the second object set is subordinate to the first object set. Alternatively, in some embodiments of the present disclosure, the first association relationship in Step S20 may also indicate a relationship that the second object set is a set member of the first object set. Alternatively, in some other embodiments of the present disclosure, the first association relationship in Step S20 may also be other suitable association relationships that enable the first object set and the second object set to be associated with each other.

For example, in some embodiments of the present disclosure, when the association relationship (such as a reference relationship or a subordination relationship) between the first object set and the second object set is established, the second object set may be selected to be added as a new set member in the first object set. Alternatively, in some embodiments of the present disclosure, when the association relationship (such as a reference relationship or a subordination relationship) between the first object set and the second object set is established, the second object set may also be selected not to be added as a set member in the first object set, that is, only the association relationship is established between the first object set and the second object set, but the second object set is not as a set member of the first object set.

For example, taking that the second object set is “subordinate” to the first object set as an example, it may refer to that an operation permission that can be performed by the second object set is limited by an operation permission that can be performed by the first object set, or it may also refer to that an information transmission boundary or an information transmission range of the second object set is limited by an information transmission boundary or an information transmission range of the first object set.

For example, taking that the first object set “references” the second object set as an example, it may refer to that the first object set and the second object set reference each other or are associated with each other, an operation permission that can be performed by the second object set is not limited by an operation permission that can be performed by the first object set, and an information transmission boundary or an information transmission range of the second object set is not limited by an information transmission boundary or an information transmission range of the first object set.

For example, in some embodiments of the present disclosure, for Step S20, the first change request in Step S10 may be a request for changing the first association relationship between the first object set and the second object set, and for example, may include establishing or releasing the first association relationship between the first object set and the second object set.

For example, taking that the first association relationship in Step S20 is a reference relationship and the first object set references the second object set (that is, the second object set is referenced by the first object set) as an example, when the reference relationship between the first object set and the second object set is established, the second object set may be selected to be added to the first object set as a set member of the first object set (certainly, in other embodiments, the second object set may also be selected not to be as a set member of the first object set, that is, only the reference relationship between the first object set and the second object set is established, but the second object set is not as a set member of the first object set), for example, some or all member objects in the second object set are added to the first object set as a group of member objects, to serve as a set member of the first object set as a whole. In this way, for example, member objects in the some or all member objects of the second object set that are not originally included in the first object set (that is, are not originally member objects of the first object set) may become member objects of the first object set in a manner that the second object set is added to the first object set as a set member, thereby helping to implement quick batch addition processing on the member objects in the first object set.

When the reference relationship between the first object set and the second object set is released, the second object set that is as the set member may be removed from the first object set, that is, the second object set no longer has a reference relationship with the first object set, and the second object set is no longer a set member of the first object set. For example, taking member objects that are originally not included in the first object set (that is, are not originally member objects of the first object set) and are added to the first object set through the second object set as an example, the member objects will also be removed from the first object set as a whole, and are no longer member objects of the first object set, thereby helping to implement quick batch removal processing on the member objects in the first object set. Thus, flexible management of the member objects in the first object set can be better implemented.

For example, in some examples, taking that the first object set is implemented as a team including a plurality of team members (for example, users) in a collaborative office application, and the second object set is implemented as a group including a plurality of group members (for example, users) in the collaborative office application as an example, the plurality of team members in the team are respectively as member objects of the team, for example, each team member may be included in the team as a single individual member, or may also be included in the team as one of a set member; and the plurality of group members in the group are respectively as member objects of the group, for example, each group member may be included in the group as a single individual member. An access entry of the team may be displayed, for example, in an operation interface provided by a client that applies the collaborative office application, and for example, a user may access the team by clicking the access entry of the team, for example, enter a team page. When the group and the team have an association relationship (for example, a reference relationship or a subordination relationship), in the case that the group is visible to the user (for example, the user has an access permission to the group), the group may be displayed in the team page, and an access entry of the group is provided in the team page, so that after entering the team page through the access entry of the team, the user may obtain related data or information about the group by clicking, for example, the access entry of the group provided in the team page. For example, when the user has the access permission to the group, the user may further access the group or enter a corresponding group page by clicking, for example, the access entry of the group provided in the team page. Thus, it is convenient for the user to find the group through the team.

For example, when the team no longer has an association relationship with the group, that is, after the association relationship is released, the group is no longer visible to the user through the team. For example, the user can no longer obtain related data or information about the group through the team. It should be noted that if the user is also a group member of the group, that is, the user belongs to both the team and the group, when the team no longer has an association relationship with the group, the user may directly access the team and the group respectively, but the group is no longer visible to the user through the team.

For example, when the team no longer has an association relationship with the group, that is, after the association relationship is released, the team and the group still exist respectively. Thus, it can help to flexibly change the association relationship between the team and the group, and at the same time, it can also reduce or avoid adverse effects that the change may have on, for example, information transmission and information exchange management, member object management, operation permission management, or the like in the team and the group.

For example, in some embodiments of the present disclosure, a set type of the first object set may be different from a set type of the second object set, for example, the first object set is a team, and the second object set is a group. For another example, in some embodiments of the present disclosure, the set type of the first object set may also be the same as the set type of the second object set, for example, both the first object set and the second object set may be groups, or may also both be teams. For example, both the team and the group described above respectively have a non-empty user member set.

Hereinafter, in some embodiments of the present disclosure, taking the first object set is a team, member objects of the team are users, the second object set is a group, member objects of the group are users, and the first association relationship between the first object set and the second object set is that the team references the group (that is, the group is referenced by the team) as an example, the interaction method provided in some embodiments of the present disclosure and each step included therein will be specifically described. It should be noted that the interaction method provided by the present disclosure includes but is not limited to this.

For example, in an exemplary application scenario of collaborative office software, a plurality of teams are created in a company, for example, including a “product-1 team” including all employees responsible for a product project 1, a “product-2 team” including all employees responsible for a product project 2, and the like. For each team, one or more groups associated with the team may also be created, for example, corresponding to groups responsible for processing different tasks of the product project. For example, for the “product-1 team,” a “daily communication group” including all employees participating in the product project 1, a “product-1 development group” including employees responsible for product development, a “product-1 operation group” including employees responsible for product operation, a “product-1 function feedback group” including employees responsible for processing user demand feedback of the product, and the like may be created, and these groups are all referenced by the team. In these groups, respective members may perform corresponding information access, exchange, sharing, or the like. For example, for the “product-2 team,” a “daily communication group” including all employees participating in the product project 2, a “product-2 development group” including employees responsible for product development, a “product-2 operation group” including employees responsible for product operation, a “product-2 function feedback group” including employees responsible for processing user demand feedback of the product, and the like may be created, and these groups are all referenced by the team. In these groups, respective members may perform corresponding information access, exchange, sharing, or the like.

For example, a member in the team may have an access permission to one or more groups associated with the team, for example, the member may belong to one or more groups associated with the team at the same time. In an operation interface of the collaborative office software used by the user, one or more teams to which the user belongs may be listed and one or more groups associated with each team may be listed under the team at the same time, so that the user can easily find the corresponding group through the team, and can perform corresponding information access, exchange, sharing, or the like in these groups. For example, because teams to which different users belong are different, and in one team, different users have access permissions to different groups, for example, belong to different groups in the team, different users obtain different use interfaces when using the collaborative office software.

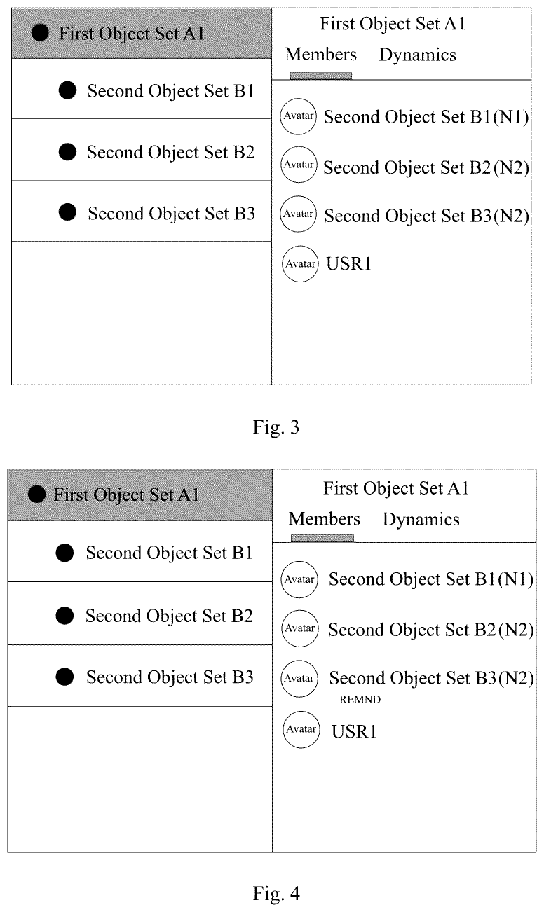

FIG. 3 to FIG. 6 are schematic diagrams of an application example based on a first object set provided by some embodiments of the present disclosure.

For example, in the example shown in FIG. 3, an association relationship between the second object sets B1 to B3 and the first object set A1 may be presented in a visualized manner. For example, in a graphical user interface of an application, the second object sets B1 to B3 are displayed as being located below the first object set A1 and indented to the right. For example, the second object sets B1 to B3 may be chat groups of instant messaging, that is, a group B1, a group B2, and a group B3, and the second object sets B1 to B3 are all associated with the first object set A1 (that is, a team A1).

For example, taking the application scenarios of the collaborative office software as an example, the first object set A1 (the team A1) may be the “product-1 team” including all employees responsible for the product project 1; the second object set B1 (that is, the group B1) may be the “daily communication group” that is associated with the team and includes all employees participating in the product project 1, for example, the daily communication group may be subordinate to the team; the second object set B2 (that is, the group B2) may be the “product-1 development group” that is associated with the team and includes employees responsible for product development, for example, the product-1 development group may be referenced by the team; and the second object set B3 (that is, the group B3) may be the “product-1 operation group” that is associated with the team and includes employees responsible for product operation, for example, the product-1 operation group may be referenced by the team.

For example, FIG. 3 shows an example of a use interface of a certain user using the collaborative office software through a client running on a user terminal. For example, the client does not display information of a team to which the user does not belong. For example, the user belongs to only the team A1 but does not belong to the team A2, and the client does not display information of the team A2 to which the user does not belong.

For example, as shown in FIG. 3, when the user belongs to a certain group associated with the team A1 or has an access permission to the certain group, or the certain group is set to be visible to the user, the client displays information of the corresponding group under the team A1, for example, the groups B1 to B3; and when the user does not belong to a certain group associated with the team A1 and does not have an access permission to the group, and the group is set to be invisible to the user, the client does not display information of the group under the team A1. For example, in addition to the groups B1 to B3 shown in FIG. 3, the team A1 also has an association relationship with other groups. For example, the team A1 also references a group B5, and the group B5 is a “management communication group” including main leaders in charge of the product project 1. When the user does not belong to the group B5 and does not have an access permission to the group B5, and the group B5 is set to be invisible to the user, the client of the user does not display information about the group B5.

For example, as shown in FIG. 3, taking that members in the team A1 include the groups B1, B2, and B3 which are respectively as set members of the team A1, and further include a member object USR1 that is as an individual member of the team A1 as an example, when the user selects the team A1 by clicking in the operation interface, or clicks a team management control (not shown in the figure), an information page of the team A1 is provided in a right-side page of the window. For example, when the user selects a tag “Members” in the information page by clicking, a member information management page is provided in the information page of the team A1; or when the user selects a tag “Dynamics” in the information page by clicking, a dynamic information display page is provided in the information page of the team A1.

For example, as shown in FIG. 3, when the tag “Members” in the information page is selected, the member information management page is provided to display individual member information and set member information of the team A1, for example, to display related information of the set members (for example, the groups B1, B2, and B3) included in the team A1, related information of the individual member USR1 included in the team A1, and the like.

For example, the set member information may include a name and an avatar of the set member, the number of member objects included (for example, N1, N2, and N3 shown in FIG. 3), and the like. For another example, in some other examples, the set member information may further include, for example, reminder information REMND about whether each member object in the group that is as the set member belongs to the team A1, and for example, the reminder information REMND may be displayed below the name of the corresponding set member. For example, as shown in FIG. 4, when each member object in the group B1 and the group B2 that are as set members belongs to the team A1, the reminder information REMND may be hidden, that is, the reminder information REMND may not be displayed below the names of the group B1 and the group B2; and when some member objects in the group B3 that is as a set member do not belong to the team A1, the reminder information REMND is displayed below the name of the group B3, for example, the reminder information REMND may be used to remind that the some member objects in the group B3 do not belong to the team A1 or have exited the team A1. For another example, in some examples of the present disclosure, the user may also select a certain set member by clicking, to view detailed information of each member object included in the corresponding group.

For example, as shown in FIG. 3, the individual member information may include a name, an avatar, and the like of the individual member. For example, in some other examples, the individual member information may further include a position held by the individual member in the team A1. For example, when the individual member is an owner or a manager of the team, such as “Team owner” or “Team manager” may be marked after the name of the individual member; and when the individual member is the owner or the manager of the team, related information of the individual member may be displayed at an uppermost position of a team member list, for example, the name and the avatar of the individual member are displayed above information of other individual members and set members.

It should be noted that in the examples shown in FIG. 3 to FIG. 6, the set member information is displayed above the individual member information in the member information management page; and in some other examples of the present disclosure, the individual member information may also be displayed above the set member information in the member information management page. Some embodiments of the present disclosure do not specifically limit the display or presentation manner, position, form, or the like of the individual member information and the set member information provided in the member information management page.

For example, in some examples of the present disclosure, the member information management page may further provide, for example, a team member search control (for example, for searching for a certain individual member or set member in the team), a team member addition control (for example, for adding a certain user or group to the team), etc. Some embodiments of the present disclosure do not specifically limit specific contents, controls, functions, and the like provided or displayed in the member information management page.

For example, when the tag “Dynamics” in the information page shown in FIG. 3 is selected, the dynamic information display page is provided in the information page of the team A1. For example, when an association relationship between the team A1 and a certain group is established or released, corresponding dynamic information is pushed and displayed in the dynamic information display page, so that a state of the association relationship between the team A1 and the group can be presented in the team A1 in a visualized manner. For another example, when one or more member objects (that is, one or more users, for example, the one or more users are also member objects of the team A1) in a certain group that is as a set member of the team A1 exit the team A1, dynamic information about the one or more member objects exiting the team A1 is pushed in the dynamic information display page of the team A1. For example, when the group is still a set member of the team A1, dynamic information about the some member objects in the group exiting the group is pushed in the dynamic information display page of the team A1, and the reminder information REMND is marked below the name of the set member corresponding to the group in the member information management page.

For example, in the above application scenario, other dynamic information about the team A1 may also be provided in the dynamic information display page of the team A1, and for example, may include state change information of the team, such as a name change of the team, a function brief change of the team, a main person in charge change of the team, a contact method change of the team, and the like. For another example, dynamic information of the team A1 may also include change information of member objects of the team, that is, dynamic information about a change of a member in the team, for example, dynamic information about a new user joining the team, dynamic information about a user leaving the team, etc. For example, the above dynamic information includes text information, voice information, video information, picture information, network link information, and the like. Some embodiments of the present disclosure do not specifically limit the type and content of the provided dynamic information. For example, the above dynamic information may be obtained by the user actively viewing the dynamic information display page of the team A1, or may also be actively pushed to the user through, for example, a message notification push channel, thereby helping the user to obtain the dynamic information related to the team in a timely and effective manner.

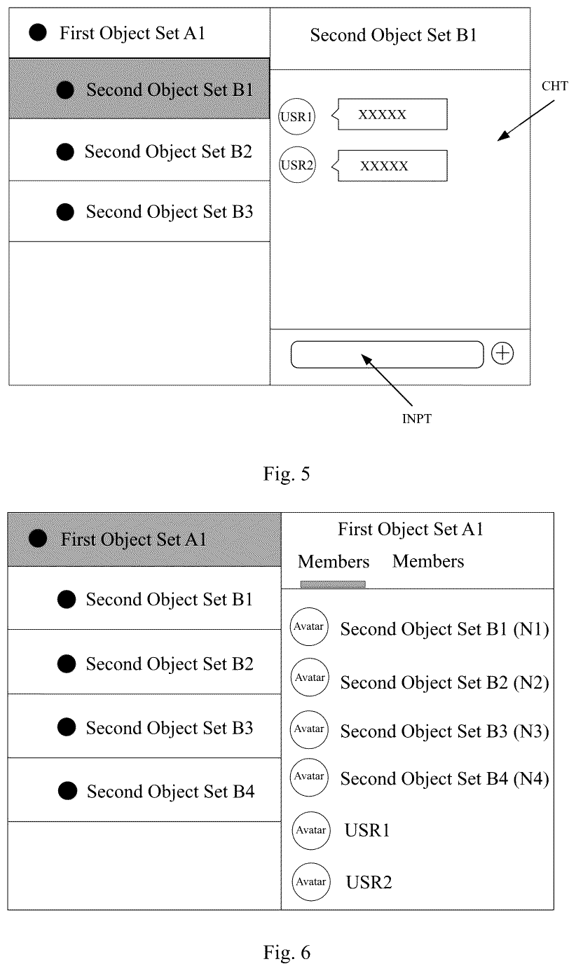

For example, as shown in FIG. 5, when the user selects the group B1 under the team A1 by clicking in the operation interface, a sub-window, such as a chat interface CHT, for each member object in the group B1 to chat and share information may be provided in the right-side page of the window, so that the user can transmit or exchange information such as the text, picture, voice, and video in the group B1. For example, the user may send or receive information such as the text, picture, voice, video, network link, or business card of the user in the chat interface CHT of the group B1, to transmit or exchange information in the group B1, or initiate an online meeting, and the like.

For example, as shown in FIG. 5, in the sub-window on the right side, the chat interface CHT is used to display information sent by the user or other users (for example, users USR1 and USR2), and the user may enter text information to be sent in an information input box INPT below the sub-window to exchange information with other users. The user may also click an “⊕” icon on the right side of the information input box INPT, and select to send other types of information in a displayed sub-interface, such as the picture, audio, video, network link, business card of the user, or the like, instead of text.

For example, in some embodiments of the present disclosure, when an association relationship is established between the team A1 and a group B4 (that is, a second object set B4), for example, the group B4 is a “product-1 function feedback group” that is associated with the team A1 and includes employees responsible for processing user demand feedback of the product, the product-1 function feedback group is for example subordinate to the team, and it may be selected to add the group B4 to the team A1 as a new set member of the team A1. For example, as shown in FIG. 6, in a left-side window of the graphical user interface of the application, the group B4 is displayed as being located below the team A1 and indented to the right, and is located below other groups B1 to B3 associated with the team A1 under the team A1. In the member information management page provided in the right-side window of the graphical user interface of the application, related information of the newly added group B4 that is as a set member of the team A1 is displayed, for example, a name and an avatar of the group B4, the number N4 of member objects included, and the like.

For example, in some embodiments of the present disclosure, as shown in FIG. 6, when a user USR2 joins the team A1 as a new individual member, in the member information management page provided in the right-side window of the graphical user interface of the application, related information of the newly added USR2 that is as an individual member of the team A1 is displayed, for example, a name and an avatar of the individual member USR2.

For example, in some embodiments of the present disclosure, an individual member of the first object set has an independent member identity attribute of the first object set, and the independent member identity attribute is not associated with any set member. For example, taking the user USR1 in the example shown in FIG. 3 as an example, the user USR1 is a member object of the team A1 and is an individual member in the team A1, and therefore, in the team A1, the user USR1 has an independent member identity attribute IDP of the team A1, and the independent member identity attribute IDP is not associated with any set member in the team A1.

For another example, in some embodiments of the present disclosure, a set member of the first object set has a set member identity attribute of the first object set, some or all member objects included in the set member of the first object set have a set-dependent member identity attribute of the first object set, and the set-dependent member identity attribute is associated with a corresponding set member. For example, taking the above user USR1 that is also a member object of the group B1 as an example, the group B1 is a set member in the team A1 and has a set member identity attribute TP1 of the team A1, and because the user USR1 is a member object of the group B1, accordingly, in addition to the independent member identity attribute IDP, the user USR1 further has a set-dependent member identity attribute DP1 of the team A1 in the team A1, and the set-dependent member identity attribute DP1 is associated with the group B1 that is as a set member of the team A1. In other words, the user USR1 has both the independent member identity attribute IDP of the team A1 and the set-dependent member identity attribute DP1 associated with the group B1 in the team A1, and the user USR1 may be a member object of the team A1 both in an identity of an individual member of the team A1 and in an identity of being included in a set member (that is, the group B1) of the team A1.

For example, for any member object in the team A1, the member object may have only the independent member identity attribute IDP of the team A1 in the team A1, or may have only a set-dependent member identity attribute DP, in the team A1, associated with a certain set member in the team A1, or may have both the independent member identity attribute IDP of the team A1 and the set-dependent member identity attribute DP in the team A1. For any member object in the team A1, regardless of whether the member object has the independent member identity attribute IDP or the set-dependent member identity attribute DP in the team A1, the member object has an information access permission to the team A1 in the team A1.

For example, in some embodiments of the present disclosure, after a reference relationship in which a team references a group is established, the group can be made visible to one or more member objects among member objects of the team which do not originally belong to the group, or an access permission to the group through the team is granted to the one or more member objects among member objects of the team which do not originally belong to the group. In this way, the one or more member objects in the team that do not originally belong to the group can obtain related information about the group in a timely and effective manner depending on the reference relationship established between the team and the group.

For example, in some examples, the access permission may include a read/write operation permission for information exchange or information transmission in the group, for example, after the access permission is granted to the member object of the team, the member object of the team may perform a read operation or a write operation on information transmission or information exchange in the group through the team. For another example, in some examples, the access permission may also include only a read-only operation permission for information exchange or information transmission in the group, for example, after the access permission is granted to the member object of the team, the member object of the team can only perform a read operation on information transmission or information exchange in the group through the team, but cannot perform a write operation or the like.

For example, in some embodiments of the present disclosure, an operation permission or an access permission of each member object in the team A1 to each group associated with the team A1 may be selectively set according to actual requirements. Taking the user USR1 in the example shown in FIG. 3 being a member object of the group B1 but not being a member object of the group B2 or the group B3 as an example, the group B2 and the group B3 may be set to be visible to the user USR1 through the team A1 in another operation interface (for example, different from the operation interface used by the user shown in FIG. 3) used by the user USR1, but the user USR1 does not have an access permission to the group B2 and the group B3 through the team A1. For another example, the group B2 and the group B3 may also be set to be visible to the user USR1 through the team A1 in the operation interface used by the user USR1, and the user USR1 has an access permission to the group B2 and the group B3 through the team A1, for example, the access permission of the user USR1 to the group B2 and the group B3 through the team A1 may be different from the access permission to the group B1, or may also be set to be the same as the access permission to the group B1. For example, the access permission of the user USR1 to different groups B2 and B3 through the team A1 may be the same or different, and some embodiments of the present disclosure do not specifically limit this.

For example, when the group B2 and the group B3 are visible to the user USR1 through the team A1, but the user USR1 does not have an access permission to the group B2 and the group B3 through the team A1, a display manner of the group B2 and the group B3 in the operation interface used by the user USR1 may be set to be different from that of the group B1. For example, the display transparency of the group B2 and the group B3 in the operation interface used by the user USR1 may be different from that of the group B1, or may also be displayed in other background colors, patterns, and the like. For example, when the user USR1 clicks on the group B2 and the group B3 in the operation interface used by the user, the user USR1 cannot access the group B2 and the group B3, for example, cannot jump to related pages of the group B2 and the group B3 or enter the group B2 and the group B3, and cannot for example participate in, consult, or browse information transmission or information exchange related to the group B2 and the group B3.

For example, when the group B2 and the group B3 are visible to the user USR1 through the team A1, and the user USR1 has an access permission with such as a read/write operation permission to the group B2 and the group B3 through the team A1, the user USRI may consult information exchange in the group B2 and the group B3 through the team A1, exchange information in the group B2 and the group B3, consult member information about member objects of the group B2 and the group B3, or exchange information alone with a specific member object of the group B2 and the group B3 in the operation interface used by the user USR1.

For example, in some embodiments of the present disclosure, taking the user USR1 being a member object of the group B4 in the example shown in FIG. 6 as an example, when the group B4 is added as a new set member to the team A1, it may be selected to add and grant a set-dependent member identity attribute DP4 associated with the group B4 that is as a new set member of the team A1 to the user USR1 in the team A1, so that the user USR1 may have both an independent member identity attribute IDP as an individual member of the team A1, a set-dependent member identity attribute DPI associated with the group B1 that is as a set member of the team A1, and a set-dependent member identity attribute DP4 associated with the group B4 that is as a set member of the team A1 in the team A1.

For example, when the group B4 is added as a new set member to the team A1, for member objects in the group B4 that do not originally belong to the team A1 (that is, are not member objects of the team A1), it may be selected whether to add these member objects to the team A1 as new member objects of the team A1. For example, it may be selected to add only some member objects among these member objects to the team A1, or it may be selected to add all these member objects to the team A1, and in the team A1, a set-dependent member identity attribute DP4, associated with the group B4, of the team A1 may be granted to the member objects selected to be added to the team A1. For example, in the process of selecting whether to add these member objects of the group B4 to the team A1, the selection may be independently determined by a manager or an owner of the group B4, or the selection may also be determined by the member objects respectively, for example, in a form of sending a message to each of the member objects.

For example, in some embodiments of the present disclosure, taking removing the group B4 that is as a set member from the team A1 in the example shown in FIG. 6 as an example, the association relationship (for example, a reference relationship) between the team A1 and the group B4 is released, and for each member object in the group B4 (or the team A1) that has a set-dependent member identity attribute DP4 associated with the group B4 in the team A1, the set-dependent member identity attribute DP4 of the member object is deleted in the team A1.

For example, taking the above user USR1 as an example, because the user USR1 still has the independent member identity attribute IDP and the set-dependent member identity attribute DP1 associated with the group B1 that is as a set member of the team A1 in the team A1 after the set-dependent member identity attribute DP4 of the user USR1 in the team A1 is deleted, the user USR1 is still included in the team A1, that is, the user USR1 still remains as a member object of the team A1.

For another example, taking another member object USR3 (that is, a user USR3) in the group B4 as an example, if the user USR3 has only the set-dependent member identity attribute DP4 of the team A1 in the team A1, after the set-dependent member identity attribute DP4 of the user USR3 in the team A1 is deleted, the user USR3 no longer has any other identity attribute in the team A1, for example, does not have the independent member identity attribute IDP and does not have a set-dependent member identity attribute associated with any other set member of the team A1, then the user USR3 is no longer a member object of the team A1, that is, the user USR3 will be removed from the team A1 and is no longer included in the team A1, in other words, the user USR3 is removed from the team A1 and cannot access information of the team A1 any more.

For example, in some embodiments of the present disclosure, taking the user USR1 in the example shown in FIG. 3 as an example, in the case that the user USR1 has the independent member identity attribute IDP and the set-dependent member identity attribute DP1 associated with the group B1 that is as a set member of the team A1 in the team A1, when a member removal request for removing the user USR1 from the team A1 is obtained, that is, when the user USR1 exits the team A1, the independent member identity attribute IDP and all other set-dependent member identity attributes of the user USR1 in the team A1 need to be deleted, for example, the set-dependent member identity attribute DPI of the user USR1 is deleted, so that the user USR1 is removed from the team A1 and is not included in the team A1. For example, although the user USR1 exits the team A1, the user USR1 does not exit the group B1, and therefore the user USR1 still belongs to the group B1, that is, the user USR1 is still a member object of the group B1.

For example, in some embodiments of the present disclosure, taking the user USR1 in the example shown in FIG. 3 as an example, in the case that the user USR1 has the independent member identity attribute IDP and the set-dependent member identity attribute DP1 associated with the group B1 that is as a set member of the team A1 in the team A1, when a member removal request for removing the user USR1 from the group B1 is obtained, that is, when the user USR1 exits the group B1, in response to the member removal request, the set-dependent member identity attribute DPI of the user USR1 in the team A1 is deleted, and the user USR1 is removed from the group B1 and is no longer included in the group B1. Because the user USR1 still has the independent member identity attribute IDP of the team A1 in the team A1, the user USR1 is still included in the team A1, that is, the user USR1 is still a member object of the team A1, and can still access information visible to the user in the team A1.

For example, in some embodiments of the present disclosure, taking the user USR2 in the example shown in FIG. 3 to FIG. 6 as an example, in the case that the user USR2 is originally a member object of the group B1 but is not a member object of the team A1, when a member adding request for adding the user USR2 to the team A1 as an individual member is obtained, as shown in FIG. 6, in response to the member adding request, the user USR2 is added to the team A1 and added as a new individual member of the team A1, and the independent member identity attribute IDP in the team A1 is granted to the user USR2. In addition, because the group B1 is a set member of the team A1, the user USR2 is further granted the set-dependent member identity attribute DP1 associated with the group B1 that is as a set member of the team A1 in the team A1. In other words, after the user USR2 joins the team A1, as a member object of the team A1, the user USR2 has both the independent member identity attribute IDP and the set-dependent member identity attribute DP1 in the team A1.

For example, in some embodiments of the present disclosure, taking the user USR2 in the example shown in FIG. 3 to FIG. 6 as an example, after the user USR2 joins the team A1 as an individual member and has the independent member identity attribute IDP and the set-dependent member identity attribute DP1 of the team A1, in the case that the user USR2 is not a member object of the group B2, when a member adding request for adding the user USR2 to the group B2 is obtained, in response to the member adding request, the user USR2 is added to the group B2 to become a new member object of the group B2, and a set-dependent member identity attribute DP2 associated with the group B2 that is as a set member of the team A1 is granted to the user USR2 in the team A1. In other words, the user USR2 will have the independent member identity attribute IDP, the set-dependent member identity attribute DP1, and the set-dependent member identity attribute DP2 in the team A1.

For example, in some embodiments of the present disclosure, taking another member object USR4 (that is, a user USR4) in the group B1 as an example, in the case that the user USR4 has only the set-dependent member identity attribute DP1 associated with the group B1 that is as a set member of the team A1 in the team A1, when a member removal request for removing the user USR4 from the group B1 is obtained, that is, the user USR4 exits the group B1, in response to the member removal request, the set-dependent member identity attribute DP1 of the user USR4 in the team A1 is deleted, and the user USR4 is removed from the group B1 and is no longer included in the group B1. Because the user USR4 no longer has any other identity attribute in the team A1, for example, does not have the independent member identity attribute IDP of the team A1 or a set-dependent member identity attribute associated with any other set member of the team A1, the user USR4 is also no longer included in the team A1, that is, the user USR4 is no longer a member object of the team A1.

For example, in some embodiments of the present disclosure, taking another member object USR5 (that is, a user USR5) as an example, in the case that the user USR5 is neither a member object of the team A1 nor a member object of any group associated with the team A1, when a member adding request for adding the user USR5 to, for example, the group B1 is obtained, in response to the member adding request, the user USR5 is added to the group B1 to become a new member object of the group B1; and at the same time, the user USR5 may also be selected to be added to the team A1, and a set-dependent member identity attribute DPI associated with the group B1 that is as a set member of the team A1 is granted to the user USR5 in the team A1, that is, the user USR5 is made to be a new member object of the team A1.

For example, in some embodiments of the present disclosure, a team is allowed to have an association relationship with one or more groups, for example, the team is allowed to have a reference relationship with one or more groups, for example, in the above application example, the team A1 may have a reference relationship with groups B2 to B4; and a group is allowed to have an association relationship with one or more teams, for example, the group is allowed to have a reference relationship with one or more teams, for example, taking the group B2 in the above application example as an example, in addition to being referenced by the team A1, the group B2 may also be referenced by other teams at the same time.

For example, in some embodiments of the present disclosure, before and after a reference relationship between the first object set and the second object set is changed, an independent operation permission of the second object set relative to the first object set remains unchanged.

For example, the independent operation permission may include an independent operation permission that can be performed by the second object set for such as information (or data) transmission, information (or data) exchange, and the like in the second object set. For example, a management permission, a control permission, or an operation permission for information transmission and information exchange in the second object set that can be performed by the second object set is not limited to the first object set. Before and after the reference relationship between the first object set and the second object set is changed, information transmission, information exchange, and the like in the second object set are managed independently by the second object set, and the first object set does not have a management permission for such as information transmission and information exchange in the second object set.

For example, the independent operation permission may further include an independent operation permission that can be performed by the second object set for each member object of the second object set. For example, before and after the reference relationship between the first object set and the second object set is changed, a change of member objects of the second object set is managed independently by the second object set, and the first object set does not have an operation permission to change the member object of the second object set.

For example, when the association relationship between the first object set and the second object set is the reference relationship, an increase/decrease operation of member objects of the second object set may be independent of an increase/decrease operation of member objects of the first object set. In other words, an operation permission for an increase/decrease operation of member objects of the second object set that can be performed by the second object set is not limited to the first object set, and an operation permission for an increase/decrease operation of member objects of the first object set that can be performed by the first object set is also not limited to the second object set. For example, the increase/decrease operation of member objects of the first object set may be managed independently by the first object set, and the increase/decrease operation of member objects of the second object set may be managed independently by the second object set.

When member objects of the first object set change, member objects of the second object set do not change. For example, when a new member object joins the first object set, the new member object does not need to be added to the second object set, or whether the new member object needs to be added to the second object set is determined or managed by the second object set; and when a member object exits the first object set, the member object does not need to exit the second object set, or whether the member object needs to exit the second object set is determined or managed by the second object set.

When member objects of the second object set change, member objects of the first object set do not change. For example, when a new member object joins the second object set, the new member object does not need to be added to the first object set, or whether the new member object needs to be added to the first object set is determined or managed by the first object set; and when a member object exits the second object set, the member object does not need to exit the first object set, or whether the member object needs to exit the first object set is determined or managed by the first object set.

For example, in some embodiments of the present disclosure, before and after the reference relationship between the first object set and the second object set is changed, the operation permission of the member object of the second object set to the second object set remains unchanged. For example, such as an information access permission, an information transmission permission, an information exchange permission, and the like of the member object of the second object set to the second object set are not affected by the change of the reference relationship between the first object set and the second object set, and are also not limited to the first object set.

For example, taking a case as an example in which before the reference relationship between the first object set and the second object set is established, member objects of the first object set include a first member object, and member objects of the second object set do not include the first member object, that is, before the reference relationship between the first object set and the second object set is established, the first member object belongs to the first object set but does not belong to the second object set, after the reference relationship between the first object set and the second object set is established, the first member object may be allowed to consult information transmission or information exchange in the second object set, transmit or exchange information in the second object set, consult member information about member objects of the second object set, exchange information alone with a specific member object of the second object set, or the like.

For another example, taking a case as an example in which before the reference relationship between the first object set and the second object set is established, member objects of the first object set include a first member object, and member objects of the second object set do not include the first member object, that is, before the reference relationship between the first object set and the second object set is established, the first member object belongs to the first object set but does not belong to the second object set, after the reference relationship between the first object set and the second object set is established, the first member object may be added as a member object of the second object set. In other words, after the reference relationship between the first object set and the second object set is established, the first member object that does not originally belong to the second object set is added to the second object set as a new member object of the second object set.

For example, the “member object of the first object set” mentioned in the present disclosure may be understood as a user or a user member of the first object set, that is, a “first user set” or a “user of the first user set,” and the “member object of the second object set” mentioned in the present disclosure may be understood as a user or a user member of the second object set, that is, a “second user set” or a “user of the second user set.”For example, in some examples, the “first object set” may be represented or understood as a “team,” an “organization,” a “group,” or a “set” that includes a plurality of users, and the “second object set” may be represented or understood as a “group” or a “set” that includes a plurality of users, for example, an instant messaging chat group for users to exchange information such as the text, picture, voice, video, or network link in the group.

For example, in some embodiments of the present disclosure, the first object set itself may not have a function of implementing information exchange, and therefore member objects of the first object set cannot directly exchange information in the form of the first object set, but need to exchange information through such as the second object set that is associated with the first object set and has an information exchange function.

It should be noted that in some other embodiments of the present disclosure, in the case that the first object set itself does not have a function of implementing information exchange and the first object set has only one second object set associated with the first object set, the first object set may not directly provide the information exchange function to the member objects of the first object set, but enables the member objects of the first object set to exchange information through the second object set, so that the first object set indirectly has the function or effect of providing information exchange. Furthermore, member objects of the second object set need to be the same as member objects of the first object set, so as to meet the requirements for all member objects of the first object set to exchange information in the form of the one second object set.

For example, in some embodiments of the present disclosure, in the case that the second object set has a first association relationship (for example, a reference relationship) with the first object set, when the first object set is disbanded, the first association relationship between the first object set and the second object set is released, and the second object set is kept.

For example, in the case that the first object set is disbanded, because the first object set no longer exists after being disbanded, the first association relationship between the first object set and the second object set also needs to be released while the first object set is disbanded. Furthermore, the release of the first association relationship does not affect the existence of the second object set, that is, the release of the first association relationship or the disbanding of the first object set will not result in the disbanding of the second object set. Therefore, after the first association relationship between the first object set and the second object set is released, the second object set still exists, for example, after the first association relationship is released, the second object set may exist independently of the first object set.

For example, in some embodiments of the present disclosure, in the case that the second object set has a first association relationship (for example, a reference relationship) with the first object set, when the second object set is disbanded, the first association relationship between the first object set and the second object set is released, and the first object set is kept.

For example, in the case that the second object set is disbanded, because the second object set no longer exists after being disbanded, the first association relationship between the first object set and the second object set also needs to be released while the second object set is disbanded. Furthermore, the release of the first association relationship does not affect the existence of the first object set, that is, the release of the first association relationship or the disbanding of the second object set will not result in the disbanding of the first object set. Therefore, after the first association relationship between the first object set and the second object set is released, the first object set still exists, for example, after the first association relationship is released, the first object set may exist independently of the second object set.

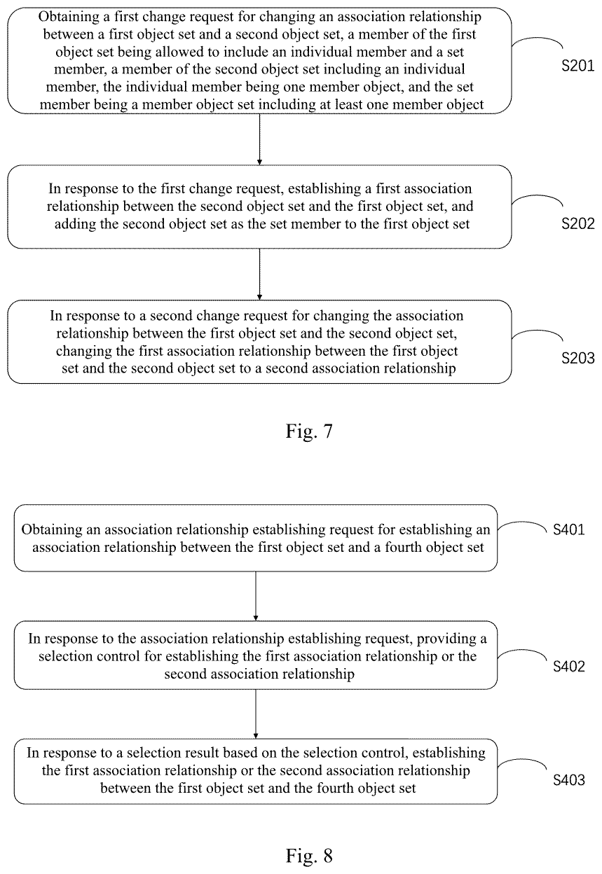

FIG. 7 is a schematic flowchart of a specific example of an interaction method provided by some embodiments of the present disclosure. It should be noted that Step S201 and Step S202 are basically the same as or similar to Step S10 and Step S20 in the interaction method shown in FIG. 2, respectively, specific descriptions of Step S201 and Step S202 may respectively refer to the related descriptions corresponding to Step S10 and Step S20 shown in FIG. 2 in the embodiments of the interaction method described above, and details will not be described again.

As shown in FIG. 7, the interaction method includes the following steps S201 to S203.

Step S201: obtaining a first change request for changing an association relationship between a first object set and a second object set, a member of the first object set being allowed to include an individual member and a set member, a member of the second object set including an individual member, the individual member being one member object, and the set member being a member object set including at least one member object.

Step S202: in response to the first change request, establishing a first association relationship between the second object set and the first object set, and adding the second object set as the set member to the first object set.

Step S203: in response to a second change request for changing the association relationship between the first object set and the second object set, changing the first association relationship between the first object set and the second object set to a second association relationship.

For example, the second association relationship is different from the first association relationship. For example, the second association relationship may be a subordination relationship or a reference relationship, or may be a relationship for indicating that the second object set is a set member of the first object set, or other suitable association relationship for associating the first object set with the second object set. For example, in some examples, the first association relationship may be a reference relationship, and the second association relationship may be a subordination relationship; or in some examples, the first association relationship may be a subordination relationship, and the second association relationship may be a reference relationship. For example, some embodiments of the present disclosure do not limit specific association types of the first association relationship and the second association relationship as long as the second association relationship is different from the first association relationship.

For example, in the above Step S203, taking the second association relationship being a subordination relationship as an example (for example, in this case, the first association relationship may be a reference relationship or the like), in the case that the first object set has the second association relationship with the second object set, the second object set has at least one subordinate operation that is controlled by the first object set, or at least some operation permissions of the second object set belong to the first object set. The second object set may be “subordinate” to the first object set, and an operation permission that can be performed by the second object set is limited to an operation permission that can be performed by the first object set, or it may also mean that an information transmission boundary or a transmission range of the second object set is limited to an information transmission boundary or a transmission range of the first object set.

For example, when the second object set is subordinate to the first object set, information change and/or information exchange in the second object set is at least partially controlled by the first object set, or at least some operations on the member objects of the first object set affect the member objects of the second object set.

For example, in some examples, in the case that the second object set is subordinate to the first object set, member objects of the second object set are consistent with member objects of the first object set. For example, when an increase operation is performed on the member objects of the first object set, an increase operation is correspondingly performed on the member objects of the second object set; or when a decrease operation is performed on the member objects of the first object set, a decrease operation is correspondingly performed on the member objects of the second object set.

For example, in an example of the interaction method shown in FIG. 7, by changing the first association relationship between the first object set and the second object set to the second association relationship, for example, taking the first association relationship being a reference relationship and the second association relationship being a subordination relationship as an example, the reference relationship between the first object set and the second object set is changed to the subordination relationship, so that the second object set is subordinate to the first object set, thereby obtaining a specific object set subordinate to the first object set. It should be noted that some embodiments of the present disclosure include but are not limited to the above situation. For example, in some embodiments of the present disclosure, a subordination relationship between the first object set and the second object set may also be changed to a reference relationship.

For example, in some embodiments of the present disclosure, when an association relationship between the first object set and a certain object set is established, the association relationship may also be directly set to such as a subordination relationship, a reference relationship, or the like.

For example, the interaction method provided in some embodiments of the present disclosure further includes the following Step S301 and Step S302.

Step S301: obtaining a second change request for changing an association relationship between the first object set and a third object set, a member of the third object set including an individual member.

Step S302: in response to the second change request, establishing a second association relationship between the first object set and the third object set, to enable the third object set to be visible to at least one member object of the first object set through the first object set.

For example, taking the second association relationship being a subordination relationship as an example, in the above Step S302, the third object set may be “subordinate” to the first object set, and an operation permission that can be performed by the third object set is limited to an operation permission that can be performed by the first object set, or it may also mean that an information transmission boundary or a transmission range of the third object set is limited to an information transmission boundary or a transmission range of the first object set. In the case that the first object set has a subordination relationship with the third object set, the third object set has at least one subordinate operation that is controlled by the first object set, or at least some operation permissions of the third object set belong to the first object set.

For example, in some embodiments of the present disclosure, the above Step S302 may further include: in response to the second change request, releasing the subordination relationship between the first object set and the third object set, to make the third object set no longer visible to the member object of the first object set through the first object set, and separately keeping the first object set and the third object set.

For example, in some embodiments of the present disclosure, before and after a subordination relationship between the first object set and the third object set is changed, for example, before and after the subordination relationship is established, or before and after the subordination relationship is released, the independent operation permission of the third object set relative to the first object set is different. For example, in the case that the first object set no longer has a subordination relationship with the third object set, the third object set no longer has a subordinate operation that is controlled by the first object set, or an operation permission of the third object set no longer belongs to the first object set.

FIG. 8 is a schematic flowchart of another specific example of an interaction method provided by some embodiments of the present disclosure. It should be noted that specific descriptions of Step S401 and Step S403 may respectively refer to the related descriptions corresponding to Step S10 and Step S20 shown in FIG. 2 and Step S201 to Step S203 shown in FIG. 7 in the embodiments of the interaction method described above, and details will not be described again.

As shown in FIG. 8, the interaction method includes the following steps S401 to S403.

Step S401: obtaining an association relationship establishing request for establishing an association relationship between the first object set and a fourth object set.

Step S402: in response to the association relationship establishing request, providing a selection control for establishing the first association relationship or the second association relationship.

Step S403: in response to a selection result based on the selection control, establishing the first association relationship or the second association relationship between the first object set and the fourth object set.

For example, in some embodiments of the present disclosure, for the above Step S401 to Step S403, taking the first object set being a team and the fourth object set being a group as an example, when an association relationship between the team and the group is established, a selection control may be provided in an operation interface of a client used by a user, so that the user may select to establish, for example, a reference relationship or a subordination relationship between the team and the group. Thus, the association relationship between the team and the group that needs to be established can be flexibly set according to the selection result provided by the user through the selection control, thereby better meeting different actual application requirements of the user.

For example, in some embodiments of the present disclosure, for a certain object set (which may be the second object set or the third object set described above, or may be other object sets, for example, the fourth object set or the like) that has an association relationship with the first object set, when the association relationship between the first object set and the associated object set N is a subordination relationship, member objects of the object set N are consistent with member objects of the first object set. For another example, when the member of the first object set is allowed to include an individual member and a set member, and the associated object set N is a set member of the first object set, at least one or more member objects included in the associated object set N have a set-dependent member identity attribute of the first object set, and the set-dependent member identity attribute is associated with the associated object set N, for example, the set member is a member object set including at least one member object. For another example, when the member of the first object set is allowed to include an individual member and a set member, and at least one or more member objects included in the associated object set N are member objects of the first object set, the associated object set N is a set member of the first object set. For another example, when member objects of the first object set include an independent member object and a set-dependent member object, at least one or more member objects in the associated object set N are set-dependent member objects of the first object set.

At least one embodiment of the present disclosure further provides an interaction method, and the interaction method includes: obtaining a first trigger operation for a first object set, a member of the first object set including an individual member and a set member, the individual member being a single member object, and the set member being a member object set including at least one member object; and in response to the first trigger operation, presenting individual member information and set member information of the first object set.

In at least one example of the interaction method provided by the above embodiment of the present disclosure, the individual member information and the set member information of the first object set may be displayed in the case that the member of the first object set includes the individual member and the set member, thereby facilitating flexible management of member objects in the first object set and quick batch change processing of member objects in the first object set.

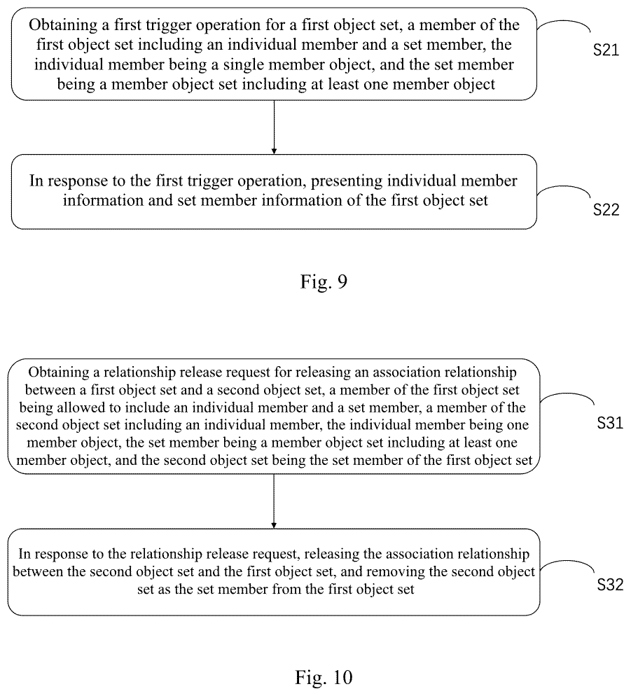

FIG. 9 is a schematic flowchart of another interaction method provided by some embodiments of the present disclosure.

As shown in FIG. 9, the interaction method provided by the embodiments of the present disclosure includes Step S21 and Step S22.

Step S21: obtaining a first trigger operation for a first object set, a member of the first object set including an individual member and a set member, the individual member being a single member object, and the set member being a member object set including at least one member object.

Step S22: in response to the first trigger operation, presenting individual member information and set member information of the first object set.

For example, in some embodiments of the present disclosure, for the above Step S21 and Step S22, the set member information may include a name, an avatar, the number of included member objects, and the like of the set member. For another example, in some examples, the set member information may further include, for example, information about member objects included in the set member, such as detailed information about each member object included in the object set that is as the set member.

For example, in some embodiments of the present disclosure, in the case that the first object set is associated with one or more second object sets and the second object set is a set member of the first object set, set member information about the second object set may provide: information about member objects of the second object set that are included in the first object set, and information about member objects of the second object set that are not included in the first object set.

For example, in some embodiments of the present disclosure, the interaction method described above further includes: obtaining a relationship establishing request for establishing an association relationship between the first object set and a second object set, and in response to the relationship establishing request, establishing the association relationship between the first object set and the second object set, and adding the second object set as the set member to the first object set. For another example, in some embodiments of the present disclosure, the interaction method described above further includes: obtaining a relationship release request for releasing an association relationship between the first object set and a second object set which is the set member of the first object set, and in response to the relationship release request, releasing the association relationship between the first object set and the second object set, and removing the second object set as the set member from the first object set.

At least one embodiment of the present disclosure further provides an interaction method, and the interaction method includes: obtaining a relationship release request for releasing an association relationship between a first object set and a second object set, a member of the first object set being allowed to include an individual member and a set member, a member of the second object set including an individual member, the individual member being one member object, the set member being a member object set including at least one member object, and the second object set being the set member of the first object set; and in response to the relationship release request, releasing the association relationship between the second object set and the first object set, and removing the second object set as the set member from the first object set.

In at least one example of the interaction method provided by the above embodiment of the present disclosure, the second object set that is a set member of the first object set may be removed from the first object set, that is, the second object set no longer has the association relationship with the first object set, and the second object set is no longer the set member of the first object set. For example, taking member objects that join the first object set through the second object set and are not originally included in the first object set (that is, are not originally member objects of the first object set) as an example, these member objects are also removed from the first object set as a whole and are no longer member objects of the first object set, so that quick batch removal processing of the member objects in the first object set may be facilitated. Therefore, flexible management of the member objects in the first object set may be facilitated.

FIG. 10 is a schematic flowchart of still another interaction method provided by some embodiments of the present disclosure.

As shown in FIG. 10, the interaction method provided by the embodiments of the present disclosure includes Step S31 and Step S32.

Step S31: obtaining a relationship release request for releasing an association relationship between a first object set and a second object set, a member of the first object set being allowed to include an individual member and a set member, a member of the second object set including an individual member, the individual member being one member object, the set member being a member object set including at least one member object, and the second object set being the set member of the first object set.

Step S32: in response to the relationship release request, releasing the association relationship between the second object set and the first object set, and removing the second object set as the set member from the first object set.

For example, for the above Step S31 and Step S32, in response to removing the second object set as the set member from the first object set, for one member object of the second object set: in the case that the individual member of the first object set includes the one member object, the one member object is still included in the first object set as the individual member; or in the case that the individual member of the first object set does not include the one member object and the one member object is not included in any other object set that is as the set member of the first object set, the one member object is no longer the member object of the first object set.

For example, in some embodiments of the present disclosure, in response to removing the second object set as the set member from the first object set, a member object in the second object set that meets a preset condition is deleted from member objects of the first object set; and the member object in the second object set that meets the preset condition includes: the member object not being the individual member of the first object set and not being included in any other object set that is as the set member of the first object set.

At least one embodiment of the present disclosure further provides an interaction method, and the interaction method includes: obtaining a first member adding request or a second member adding request for adding a user to a first object set, an association relationship being present between the first object set and a second object set, and the second member adding request being a request for adding the user to the first object set through the second object set when the user is a member object of the second object set; and in response to the first member adding request, adding the user to the first object set to enable the user to become a member object of the first object set, and granting a first member identity attribute to the user in the first object set, or in response to the second member adding request, adding the user to the first object set through the second object set, to enable the user to become a member object of the first object set, and granting a second member identity attribute to the user in the first object set, the second member identity attribute being associated with the second object set.

In at least one example of the interaction method provided by the above embodiment of the present disclosure, the user may be added to the first object set in different manners in response to the first member adding request and the second member adding request which are different, respectively, so that the user joining the first object set in different manners may have different member identity attributes in the first object set, thereby facilitating flexible management of the member object in the first object set.

FIG. 11 is a schematic flowchart of still another interaction method provided by some embodiments of the present disclosure. The interaction method may be applied to the server 130 in the system 100 shown in FIG. 1, or may be applied to the user terminal 110, or may be applied to both the server 130 and the user terminal 110. For example, a user such as a person may access the server 130 through the user terminal 110 and perform an operation through an operation interface provided by client software on the user terminal 110, and the interaction method is, for example, applied to a collaborative office application or a social application on the user terminal 110.

As shown in FIG. 11, the interaction method provided by the embodiments of the present disclosure includes Step SP10 and Step SP20.

Step SP10: obtaining a first member adding request or a second member adding request for adding a user to a first object set, an association relationship being present between the first object set and a second object set, and the second member adding request being a request for adding the user to the first object set through the second object set when the user is a member object of the second object set.

Step SP20: in response to the first member adding request, adding the user to the first object set to enable the user to become a member object of the first object set, and granting a first member identity attribute to the user in the first object set; or in response to the second member adding request, adding the user to the first object set through the second object set, to enable the user to become a member object of the first object set, and granting a second member identity attribute to the user in the first object set, the second member identity attribute being associated with the second object set.

For example, for the above Step SP10, the first object set may include one or more member objects, and the member object may be a user or a user member. For example, taking the interaction method provided by the embodiments of the present disclosure being applied to a collaborative office application as an example, the user may refer to a real person or entity that uses a related device or network service, that is, a real user. Alternatively, the member object in the first object set may also be a computer program set in the system such as a chat robot or a service assistant that can simulate human conversation and is used to provide service.

For example, the second object set may include one or more member objects, and the one or more member objects may be, for example, various types of member objects belonging to the second object set with different attributes, different functions, or for different operations. For example, a member object of the second object set may be a user or a user member, or may refer to a computer program set in the system such as a chat robot or a service assistant that can simulate human conversation and is used to provide service. For example, taking the interaction method provided by the embodiments of the present disclosure being applied to a collaborative office application as an example, the user may refer to a real person or entity that uses a related device or network service, that is, a real user.

For example, in some examples, object types of member objects of the first object set may be the same as or different from each other, and object types of member objects of the second object set may be the same as or different from each other. For example, each of the member objects of the first object set and the second object set may be a real person or entity that uses a related device or network service, or the member objects of the first object set and the second object set may include both a real user and a computer program such as a chat robot or a service assistant that provides a service.

For example, there may be an association relationship between the first object set and the second object set. For example, the association relationship may be a reference relationship (for example, the first association relationship), for example, the first object set references the second object set, or the second object set references the first object set. For another example, the association relationship may be a subordination relationship (for example, the second association relationship), for example, the first object set is subordinate to the second object set, or the second object set is subordinate to the first object set. Alternatively, in some other examples, the association relationship may also be other suitable association relationships for associating the first object set with the second object set, and some embodiments of the present disclosure do not specifically limit this.

For example, taking the second object set being “subordinate” to the first object set as an example, it may mean that an operation permission that can be performed by the second object set is limited to an operation permission that can be performed by the first object set, or it may also mean that an information transmission boundary or a transmission range of the second object set is limited to an information transmission boundary or a transmission range of the first object set.

For example, taking the first object set “referencing” the second object set as an example, it may mean that the first object set and the second object set reference each other and are associated with each other, an operation permission that can be performed by the second object set is not limited to an operation permission that can be performed by the first object set, and an information transmission boundary or a transmission range of the second object set is not limited to an information transmission boundary or a transmission range of the first object set.

For example, in some embodiments of the present disclosure, the member adding request may be understood as a request for adding a user that is not originally included in the first object set (that is, is not originally a member object of the first object set) to the first object set, so that the user becomes a member object of the first object set.

For example, the first member adding request may refer to a request for adding the user directly to the first object set, and there is no need to use, for example, another object set associated with the first object set. For example, the second member adding request may refer to a request for adding the user to the first object set through the second object set when the user is a member object of the second object set that has an association relationship with the first object set (that is, when the user is included in the second object set).

For example, in some examples, taking the first object set being implemented as a team that includes a plurality of team members (for example, users or user members) in a collaborative office application, and the second object set being implemented as a group that includes a plurality of group members (for example, users or user members) in the collaborative office application as an example, the plurality of team members in the team are respectively as member objects of the team, and the plurality of group members in the group are respectively as member objects of the group. For example, an access entry of the team may be displayed in an operation interface provided by a client that applies the collaborative office application, and the user may access the team, for example, enter a team page, by clicking on the access entry of the team. When there is an association relationship between the group and the team, in the case that the group is visible to the user (for example, the user has an access permission to the group), the group may be displayed in the team page, and an access entry of the group may be provided, so that the user can obtain related data or information about the group by clicking on the access entry of the group provided in the team page after entering the team page through the access entry of the team. For example, when the user has the access permission to the group, the user may also access the group or enter a corresponding group page by clicking on the access entry of the group provided in the team page. Thus, it is convenient for the user to find the group through the team.

For example, when the team no longer has an association relationship with the group, that is, after the association relationship is released, the group is no longer visible to the user through the team. For example, the user can no longer obtain related data or information about the group through the team. It should be noted that if the user is also a group member of the group, that is, the user is respectively included in the team and the group, when the team no longer has an association relationship with the group, the user may directly access the team and the group respectively, but the group is no longer visible to the user through the team.

For example, when the team no longer has an association relationship with the group, that is, after the association relationship is released, the team and the group still exist separately. Therefore, the association relationship between the team and the group may be flexibly changed, and adverse effects that may be caused to, for example, information transmission and information exchange management, member object management, operation permission management, and the like in the team and the group by the change may also be reduced or avoided.

For example, taking the example of the team and the group as an example, the first member adding request may refer to a request for adding the user directly to the team to become a team member of the team. For example, the user may directly apply to the team for joining the team, and for example, after the team (for example, an owner, an administrator, or other team members having permission to process the application) agrees to the application of the user or the application is set to be automatically agreed to or be passed by default, the first member adding request is created. For another example, the team may also directly send a join invitation to the user, and for example, after the user agrees to the invitation or the invitation is set to be automatically agreed to or be passed by default, the first member adding request is created.

For example, taking the example of the team and the group as an example, the second member adding request may refer to a request for adding the user to the team through the group to become a team member of the team when the user is included in a group associated with the team (that is, the user is a group member of the group). For example, after the user joins the team through the group, the user is both a group member of the group and a team member of the team. For example, when an association relationship between the team and the group is established, a person with permission (such as an initiator or establisher of the association relationship, a team administrator, a group administrator, or other team members having permission to process the operation) may select whether to add some or all group members in the group to the team through the group, to make the some or all group members become team members of the team, or each group member in the group may select whether to join the team through the group to become a team member of the team. After the group member is selected by the person with permission to join the team through the group or the group member selects to join the team through the group, the second member adding request is created. For another example, after the association relationship between the team and the group is established, a group member in the group that is not a team member (that is, is not included in the team) may select whether to join the team through the group to become a team member of the team, and after the group member selects to join the team through the group, the second member adding request is created. For another example, after the association relationship between the team and the group is established, when a new group member joins the group, in the case that the new group member is not a team member of the team (that is, is not included in the team), a person with permission may select whether to add the new group member to the team through the group to become a team member of the team, or the new group member may select whether to join the team through the group to become a team member of the team. After the new group member is selected on the group to join the team through the group or the new group member selects to join the team through the group, the second member adding request is created.

For example, in some embodiments of the present disclosure, for the above Step SP20, when the first member adding request is responded to, the user is added to the first object set to become a member object of the first object set, and the user has a first member identity attribute IDP1 in the first object set; and when the second member adding request is responded to, the user is added to the first object set to become a member object of the first object set, and the user has a second member identity attribute IDP2 in the first object set, the second member identity attribute IDP2 being associated with the second object set. When the first member adding request and the second member adding request which are different are responded to, the user may be added to the first object set in different manners, and the user may respectively have different member identity attributes in the first object set, for example, the first member identity attribute IDP1 and the second member identity attribute IDP2, thereby facilitating flexible management of the member objects in the first object set.

For example, in some embodiments of the present disclosure, for the second member identity attribute IDP2, for example, when a user that is not originally included in the first object set (the user is a member object of the second object set) joins the first object set through the second object set associated with the first object set, the second member identity attribute IDP2 associated with the second object set may be granted to the user in the first object set. For another example, when the first object set is associated with the second object set, for the user that is originally included in the first object set (the user is a member object of the second object set), the second member identity attribute IDP2 associated with the second object set may be additionally granted to the user. For another example, after an association relationship between the first object set and the second object set is established, for a member object of the first object set that is not included in the second object set, when an information access permission of the second object set through the first object set is granted to the member object, the second member identity attribute IDP2 associated with the second object set may also be granted to the member object. For another example, after the association relationship between the first object set and the second object set is established, when a member object of the first object set that is not originally included in the second object set joins the second object set, the second member identity attribute IDP2 associated with the second object set may be granted to the member object. In other words, an assignment approach of the second member identity attribute IDP2 in the first object set includes but is not limited to the case in the above Step SP20.

For example, in some embodiments of the present disclosure, if the user joins the first object set through a third object set associated with the first object set, the user has a third member identity attribute IDP3 associated with the third object set in the first object set. For example, in the case that there are association relationships respectively between the first object set and a plurality of object sets (for example, the second object set, the third object set, etc.), the second member identity attribute IDP2 is associated with the second object set among the plurality of object sets, the third member identity attribute IDP3 is associated with the third object set among the plurality of object sets, and the first member identity attribute IDP1 is not associated with any one of the plurality of object sets.

For example, in some embodiments of the present disclosure, a member object of the first object set may have only one member identity attribute in the first object set, for example, only the first member identity attribute IDP1, only the second member identity attribute IDP2, or only the third member identity attribute IDP3. For another example, in some embodiments of the present disclosure, a member object of the first object set may also have a plurality of member identity attributes in the first object set at the same time, for example, both the first member identity attribute IDP1 and the second member identity attribute IDP2, both the first member identity attribute IDP1 and the third member identity attribute IDP3, both the second member identity attribute IDP2 and the third member identity attribute IDP3, or all the first member identity attribute IDP1, the second member identity attribute IDP2, and the third member identity attribute IDP3.

For example, in some embodiments of the present disclosure, for each member object in the first object set, according to different member identity attributes that each member object has in the first object set, operation permissions of the member objects in the first object set may be the same as or different from each other.

For example, in the case that there are association relationships between the first object set and a plurality of object sets, the first member identity attribute IDP1 that is not associated with any one of the plurality of object sets may enable the user to have a first operation permission in the first object set, and a member identity attribute (for example, the second member identity attribute IDP2, the third member identity attribute IDP3, or the like) associated with one of the plurality of object sets may enable the user to have a second operation permission in the first object set, and the first operation permission may be the same as the second operation permission, or the first operation permission may also be different from the second operation permission.

For example, taking the first member identity attribute IDP1 and the second member identity attribute IDP2 as an example, for member objects USR1 and USR2 (for example, users USR1 and USR2, or user members USR1 and USR2) in the first object set, in the case that the member object USR1 has only the first member identity attribute IDP1 in the first object set and the member object USR2 has only the second member identity attribute IDP2 in the first object set, in some examples, the member objects USR1 and USR2 may have the same operation permission in the first object set; or in some other examples, the member objects USR1 and USR2 may also have different operation permissions in the first object set.

For example, in some embodiments of the present disclosure, a set type of the first object set may be different from a set type of the second object set, for example, the first object set is a team, and the second object set is a group. For another example, in some embodiments of the present disclosure, the set type of the first object set may also be the same as the set type of the second object set, for example, both the first object set and the second object set may be groups, or both the first object set and the second object set may be teams. For example, the above team or group may have a non-empty user member set.

Hereinafter, in some embodiments of the present disclosure, taking the case that the first object set is a team, a member object (that is, a team member) of the team is a user (that is, a user member), the second object set is a group, and a member object (that is, a group member) of the group is a user (that is, a user member) as an example, the interaction method and each step included therein provided in some embodiments of the present disclosure are specifically described. It should be noted that the interaction method provided in the present disclosure includes but is not limited to this.

For example, in an exemplary application scenario of collaborative office software, a plurality of teams are created in a company, for example, including a “product-1 team” including all employees responsible for a product project 1, a “product-2 team” including all employees responsible for a product project 2, and the like. For each team, one or more groups associated with the team may also be created, for example, corresponding to groups responsible for handling different tasks of the product project. For example, for the “product-1 team,” a “daily communication group” including all employees participating in the product project 1, a “product-1 development group” including employees responsible for product development, a “product-1 operation group” including employees responsible for product operation, a “product-1 function feedback group” including employees responsible for handling user demand feedback of the product, and the like may be created, these groups are all associated with the team, and in these groups, respective members may perform corresponding information access, communication, sharing, and the like. For example, for the “product-2 team,” a “daily communication group” including all employees participating in the product project 2, a “product-2 development group” including employees responsible for product development, a “product-2 operation group” including employees responsible for product operation, a “product-2 function feedback group” including employees responsible for handling user demand feedback of the product, and the like may be created, these groups are all associated with the team, and in these groups, respective members may perform corresponding information access, communication, sharing, and the like.

For example, a team member in the team may have an access permission, for example, an information access permission, to one or more groups associated with the team, for example, the team member may be simultaneously included in the one or more groups associated with the team, that is, may also be a group member of the one or more groups at the same time. In an operation interface of the collaborative office software used by the user, one or more teams to which the user belongs may be listed, and the one or more groups associated with the team may be listed under each team, so that the user can conveniently find a corresponding group through the team, and can perform corresponding information access, communication, sharing, and the like in these groups. For example, since different users belong to different teams, and different users have different access permissions or information access permissions to different groups in one team, for example, users may be group members of different groups, the user interfaces obtained by different users when using the collaborative office software are different.

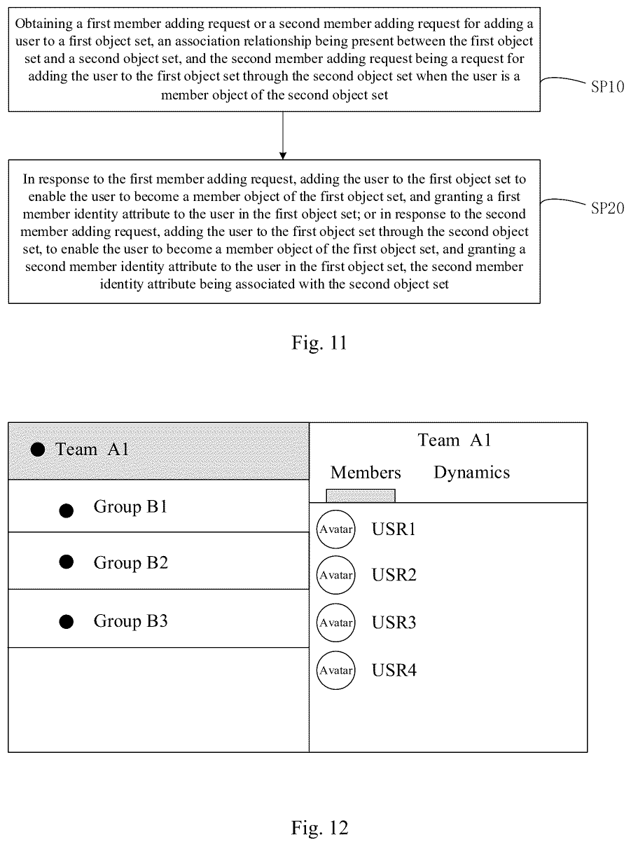

FIG. 12 to FIG. 17 are schematic diagrams of an application example based on the first object set provided by some embodiments of the present disclosure, respectively.

For example, in the example shown in FIG. 12, the association relationship between the groups B1 to B3 and the team A1 may be presented in a visualized manner. For example, in a graphical user interface of an application, the groups B1 to B3 are displayed under the team A1 and are indented to the right. For example, the groups B1 to B3 may be chat groups for instant messaging, and the groups B1 to B3 are all associated with the team A1.

For example, taking the above application scenario of the collaborative office software as an example, the team A1 may be a “product-1 team” including all employees responsible for the product project 1, and the group B1 may be a “daily communication group” associated with the team and including all employees participating in the product project 1, for example, the daily communication group may be subordinate to the team; the group B2 may be a “product-1 operation group” associated with the team and including employees responsible for product operation, for example, the product-1 operation group may be referenced by the team; and the group B3 may be a “product-1 development group” associated with the team and including employees responsible for product development, for example, the product-1 development group may be referenced by the team.

For example, FIG. 12 shows an example of a user interface of a certain user (for example, the user USR1 or the user member USR1) using the collaborative office software through a client running in a user terminal. For example, the client does not display information about a team to which the user does not belong. For example, the user belongs only to the team A1 and does not belong to the team A2, and the client does not display information about the team A2 to which the user does not belong.

For example, as shown in FIG. 12, when the user is a group member of a group associated with the team A1 or has an access permission or information access permission to a certain group, or a certain group is set to be visible to the user, the client will display information about the corresponding group under the team A1, for example, the groups B1 to B3; and when the user is not a group member of a group associated with the team A1, does not have an access permission or information access permission to the group, and the group is set to be invisible to the user, the client will not display information about the group under the team A1. For example, in addition to the groups B1 to B3 shown in FIG. 12, the team A1 also has association relationships with other groups, for example, the team A1 also has an association relationship with a group B5, and the group B5 is a “management item communication group” including the main person in charge of the product project 1. When the user is not a group member of the group B5, does not have an access permission or information access permission to the group B5, and the group B5 is set to be invisible to the user, the client of the user will not display information about the group B5.

For example, taking an example in which FIG. 12 shows an operation interface of a collaborative office software used by the user USR1, and the user USR1 has information access permissions to the group B1, the group B2, and the group B3, respectively, when the user USR1 selects the team A1 through clicking in the operation interface or clicks on a team management control (not shown in the figure), an information page of the team A1 will be provided in a right page of the window. When the user USR1 selects a tag “Members” through clicking in the information page, a team member information management page of the team A1 will be provided in the information page; or when the user USR1 selects a tag “Dynamics” through clicking in the information page, a dynamic information display page of the team A1 will be provided in the information page.

For example, as shown in FIG. 12, when the tag “Members” in the information page is selected, the member information management page is provided to display team member information of the team A1, for example, to display related information of team members USR1, USR2, USR3, and USR4 included in the team A1. It should be noted that, for example, taking an example in which FIG. 12 shows the operation interface of the collaborative office software used by the user USR1, in some examples, related information of the user USR1 is also displayed in the member information management page; or in some other examples, the related information of the user USR1 may not be displayed in the member information management page, and some embodiments of the present disclosure do not specifically limit this.

For example, as shown in FIG. 12, the team member information provided in the member information management page may include a name, an avatar, and the like of the team member. For example, in some other examples, the team member information provided in the member information management page may further include a position held by the team member in the team A1. For example, when the team member is an owner or an administrator of the team, a “team owner” or “team administrator” may be marked after the name of the team member, and when the team member is an owner or an administrator of the team, related information of the team member may be displayed at an uppermost position of a team member list, for example, the name and avatar of the team member are displayed above information of other team members.

For example, in some embodiments of the present disclosure, the team member information provided in the member information management page may further include a member identity attribute of the team member in the team, for example, a first member identity attribute IDP1 in the team A1 that is not associated with any one of the group B1, the group B2, the group B3, or the like, a second member identity attribute IDP2 associated with the group B1, a third member identity attribute IDP3 associated with the group B2, or a fourth member identity attribute IDP4 associated with the group B3.

For example, in the member information management page, related information of team members with different member identity attributes may be displayed in different display styles, respectively. For example, related information of a team member with the first member identity attribute IDP1 may be displayed in the member information management page in a first display style, and related information of a team member with the second member identity attribute IDP2 may be displayed in the member information management page in a second display style. For example, the first display style is different from the second display style, for example, different display colors, transparencies, font forms, pattern identifiers, or text identifiers may be used for distinction, and some embodiments of the present disclosure do not specifically limit this.

It should be noted that some embodiments of the present disclosure do not specifically limit a display or presentation mode, a position, a form, and the like of the team member information provided in the member information management page.

For example, in some examples of the present disclosure, the member information management page may further provide, for example, a team member search control (for example, for searching for a certain team member in the team), a team member adding control (for example, for adding a certain user to the team), and the like, and some embodiments of the present disclosure do not specifically limit specific contents, controls, functions, or the like provided or displayed in the member information management page.

For example, in some examples of the present disclosure, when the tag “Dynamics” in the information page shown in FIG. 12 is selected, the dynamic information display page of the team A1 will be provided in the information page. For example, when an association relationship between the team A1 and a certain group is established or released, corresponding dynamic information will be pushed and displayed in the dynamic information display page, so that a status of the association relationship between the team A1 and the group may be presented in the team A1 in a visualized manner.

For example, in the above application scenario, other dynamic information about the team A1 may also be provided in the dynamic information display page of the team A1, for example, the dynamic information may include state change information of the team, for example, including a name change of the team, a function brief change of the team, a main person in charge change of the team, a contact information change of the team, and the like. For another example, the dynamic information of the team A1 may also include change information of team members of the team, that is, dynamic information about a change of member objects in the team, for example, dynamic information about a new user joining the team, dynamic information about a user leaving the team, and the like.

For example, the above dynamic information includes text information, voice information, video information, picture information, or network link information, and some embodiments of the present disclosure do not specifically limit a type, a content, or the like of the provided dynamic information. For example, the above dynamic information may be obtained by the user actively viewing the dynamic information display page of the team, or may also be actively pushed to the user through such as a message notification push channel, thereby facilitating the user to obtain the dynamic information related to the team in a timely and effective manner.

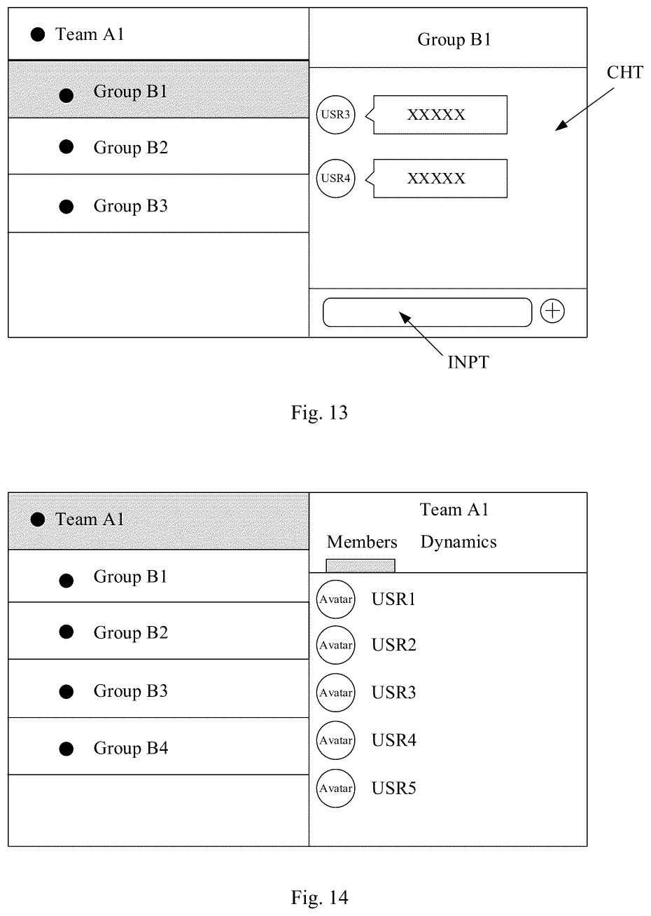

For example, taking an example in which FIG. 12 and FIG. 13 show an operation interface of a collaborative office software used by the user USR1, and the user USR1 is a group member of the group B1, as shown in FIG. 13, for example, when the user USR1 selects the group B1 under the team A1 through clicking in the operation interface, a sub-window, such as a chat interface CHT, for each group member in the group B1 to chat and share information, may be provided in a right page of the window, so that the user USR1 can perform information transmission or information exchange in the group B1, for example, transmission or exchange for the text, picture, voice, video, and the like in the group B1. For example, the user USR1 may send or receive information, such as the text, picture, voice, video, network link, or user business card, in the chat interface CHT of the group B1, to implement information transmission or information exchange in the group B1, or the user USR1 may also initiate an online meeting or the like.

For example, as shown in FIG. 13, in the sub-window on the right, the chat interface CHT is used to display information sent by the user USRI or other users (for example, the users USR3 and USR4), and the user USR1 may input text information to be sent in an information input box INPT below the sub-window, to perform information exchange with other users. The user USR1 may also click on an icon “⊕” on the right side of the information input box INPT, and select, in a displayed sub-interface, to send other types of information other than the text, for example, to send the picture, audio, video, network link, or user business card.

For example, taking an example in which FIG. 12 to FIG. 14 show an operation interface of a collaborative office software used by the user USR1, and the user USR1 is not a group member of the group B4 and has the first member identity attribute IDP1 in the team A1, in some examples, as shown in FIG. 14, after an association relationship between the team A1 and the group B4 is established, for example, the group B4 is a “product-1 function feedback group” being associated with the team A1 and including employees responsible for handling user demand feedback of the product, and the group B4 may be set to be visible to the user USR1 in the team A1. For example, in a left window of a graphical user interface of an application, the group B4 is displayed under the team A1 and is indented to the right, and is located below other groups B1 to B3 associated with the team A1 under the team A1.

For example, in some other examples of the present disclosure, after the association relationship between the team A1 and the group B4 is established, the group B4 may also be set to be, for example, invisible to team members of the team A1 that are not included in the group B4 (that is, not group members of the group B4). For example, in this case, the group B4 will not be displayed under the team A1 in the operation interface of the collaborative office software used by the user USR1.

For example, in some examples of the present disclosure, as shown in FIG. 14, when the association relationship between the team A1 and the group B4 is established, a group member USR5 that is originally not included in the team A1 (that is, originally not a team member of the team A1) in the group B4 may be selected to be added to the team A1 as a new team member of the team A1, and a fifth member identity attribute IDP5 associated with the group B4 is granted to the user USR5 in the team A1, that is, the user USR5 has the fifth member identity attribute IDP5 associated with the group B4 in the team A1. For example, taking the operation interface of the collaborative office software used by the user USR1 shown in FIG. 14 as an example, after the group member USR5 is added to the team A1, related information of the user USR5 is displayed in the member information management page provided in the right window, for example, the related information of the user USR5 is located below related information of other team members in the team A1.

For example, in some examples of the present disclosure, after the association relationship between the team A1 and the group B4 is established, the user USR1 may also have an information access permission to access the group B4 through the team A1. Therefore, the user USR1 that is originally not included in the group B4 may obtain related information about the group B4 in a timely and effective manner through the team A1 as a team member of the team A1.

For example, in some examples, the above information access permission may include a read-write operation permission for information exchange or information transmission in the group B4. For example, after the user USR1 has the information access permission to the group B4 through the team A1, the user USR1 may perform a read operation or a write operation on information transmission or information exchange in the group B4 through the team A1. For another example, in some examples, the above information access permission may also include only a read-only operation permission for information exchange or information transmission in the group B4. For example, after the user USR1 has the information access permission to the group B4 through the team A1, the user USR1 may only perform a read operation on information transmission or information exchange in the group B4 through the team A1, and cannot perform a write operation or the like.

It should be noted that the information access permission of the user USR1 to the group B4 through the team A1 may be selected and set according to actual requirements, and some embodiments of the present disclosure do not specifically limit this.

For example, in some examples, when the user USR1 is not a group member of the group B4 and does not have the fifth member identity attribute IDP5 associated with the group B4 in the team A1, the user USR1 may have the first information access permission to access the group B4 through the team A1; and for a user USR5 that has the fifth member identity attribute IDP5 associated with the group B4 in the team A1, the user USR5 may have a second information access permission to access the group B4 through the team A1, and the first information access permission is different from the second information access permission.

For example, the first information access permission is lower than the second information access permission. For example, the first information access permission is a read-only operation permission that only a read operation may be performed on information exchange or information transmission in the group B4, and the second information access permission is a read-write operation permission that a read operation or a write operation may be performed on information exchange or information transmission in the group B4.

For example, in some embodiments of the present disclosure, taking an example in which the user USR1 has the first member identity attribute IDP1 in the team A1, and the user USR5 that is newly added to the team A1 has the fifth member identity attribute IDP5 associated with the group B4 in the team A1 and does not have the first member identity attribute IDP1 in the team A1, after an association relationship between the team A1 and the group B4 is established and the user USR5 is added to the team A1, in some examples, the user USR1 that has the first member identity attribute IDP1 in the team A1 has a third information access permission, in the team A1, to information in the team A1, and the user USR5 that does not have the first member identity attribute IDP1 in the team A1 has a fourth information access permission, in the team A1, to information in the team A1, the fourth information access permission being different from the third information access permission.

For example, in some examples, the fourth information access permission is lower than the third information access permission. For example, data or information accessible, operable, or obtainable by the user USR1 in the team A1 is more than data or information accessible, operable, or obtainable by the user USR5 in the team A1. For example, compared with the user USR1, the user USR5 may not have an access, obtaining, or operation permission, in the team A1, to some information or data in the team A1.

For example, the third information access permission and the fourth information access permission may include one or more of the following: allowing to consult information exchange in the team A1, allowing to perform information exchange in the team A1, allowing to consult member information about team members of the team A1, or allowing to perform individual information exchange with a specific member object of the team A1.

For example, in some embodiments of the present disclosure, for any team member in the team A1, whether the team member has the first member identity attribute IDP1 in the team A1 or has a member identity attribute associated with a certain group, for example, the second member identity attribute IDP2, the third member identity attribute IDP3, the fourth member identity attribute IDP4, the fifth member identity attribute IDP5, or the like, in the team A1, the team member has an information access permission to the team A1.

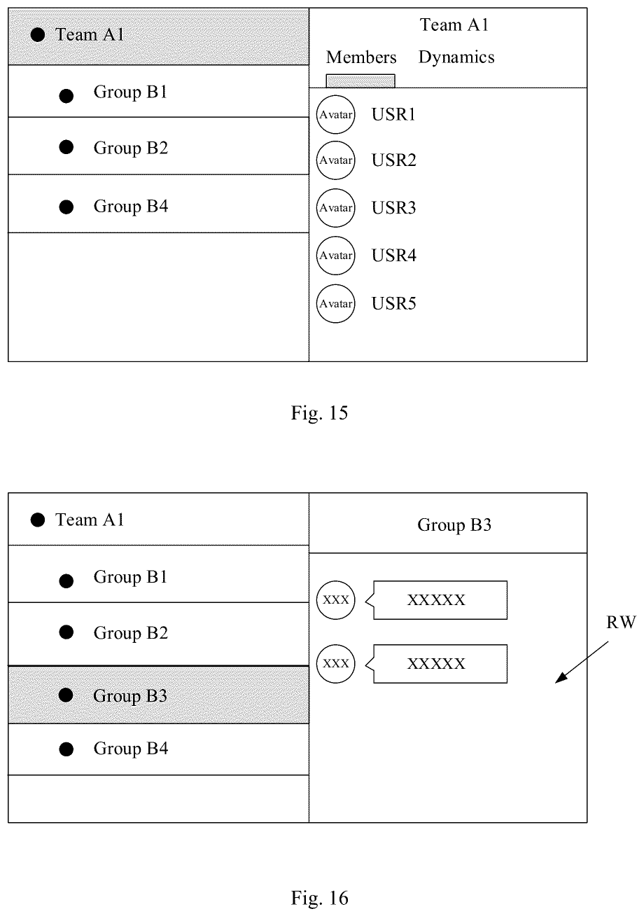

For example, in some examples of the present disclosure, taking an example in which, in the team A1, the group B1 and the group B2 are set to be visible to any team member in the team A1, and the group B3 is set to be visible only to a team member with the first member identity attribute IDP1 or with a fourth member identity attribute IDP4 associated with the group B3 in the team A1, for the user USR1 with the first member identity attribute IDP1 in the team A1, the group B1, the group B2, and the group B3 are all visible to the user USR1, for example, an operation interface of the collaborative office software used by the user USR1 may refer to FIG. 14; and for the user USR5 that does not have the first member identity attribute IDP1 and does not have the fourth member identity attribute IDP4 associated with the group B3 in the team A1, the group B1 and the group B2 are visible to the user USR5, and the group B3 is invisible to the user USR5, for example, an operation interface of the collaborative office software used by the user USR5 may refer to FIG. 15.

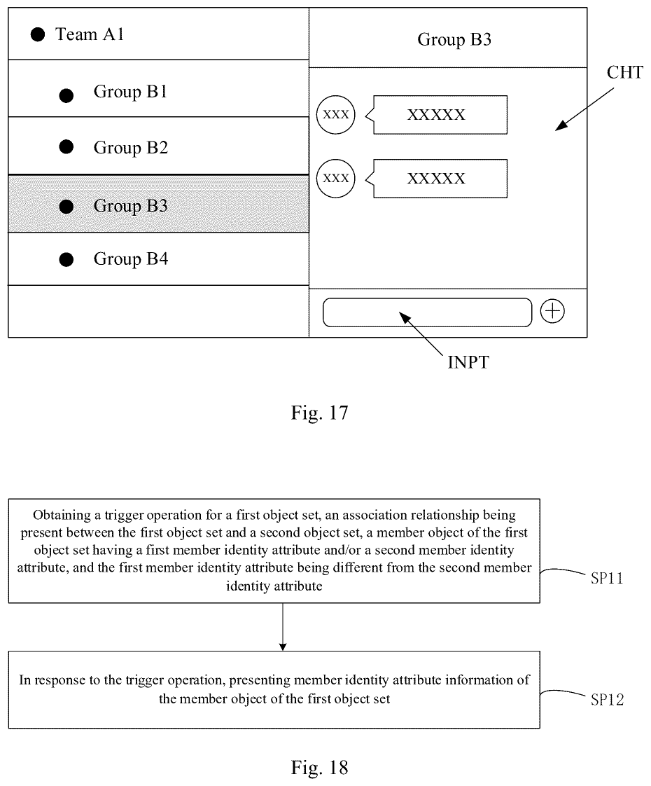

For another example, in some examples of the present disclosure, taking an example in which, in the team A1, the group B1, the group B2, and the group B3 are all set to be visible to any team member in the team A1, a team member with the first member identity attribute IDP1 or with a fourth member identity attribute IDP4 associated with the group B3 in the team A1 has a fifth information access permission to the group B3 through the team A1, and a team member that does not have the first member identity attribute IDP1 and does not have the fourth member identity attribute IDP4 associated with the group B3 in the team A1 has a sixth information access permission to the group B3 through the team A1, the sixth information access permission is lower than the fifth information access permission. For example, the sixth information access permission may be a read-only operation permission that only a read operation may be performed on information exchange or information transmission in the group B3, and the fifth information access permission may be a read-write operation permission that a read operation or a write operation may be performed on information exchange or information transmission in the group B3. For example, for the user USR1 with the first member identity attribute IDP1 in the team A1, the user USR1 may, for example, perform a read operation or a write operation on information exchange or information transmission in the group B3 through the team A1, for example, an operation interface of the collaborative office software used by the user USR1 may refer to FIG. 17. For example, for the user USR5 that does not have the first member identity attribute IDP1 and does not have the fourth member identity attribute IDP4 associated with the group B3 in the team A1, the user USR5 may, for example, only perform a read operation on information exchange or information transmission in the group B3 through the team A1, for example, an operation interface of the collaborative office software used by the user USR5 may refer to FIG. 16.

For example, in the example shown in FIG. 16, in an operation interface of the collaborative office software used by the user USR5, when the user USR5 selects the group B3 under the team A1 through clicking in the operation interface, an interface RW allowing the user USR5 to query or browse related information or data, such as the text, picture, voice, video, or the like, in the group B3 is provided in a right page of the window, but the user USR5 cannot input or send information, such as the text, picture, voice, video, or the like, in the interface RW, that is, the user USR5 cannot perform information exchange with other users in the group B3 through the interface RW. In some embodiments, a control “Join the group” may also be set on a group interface under the team that only provides a browse permission to a current user. In response to the current user triggering the control “Join the group,” the user directly joins the group without approval and verification, or the user joins the group after an approval and verification process. After joining the group, the user may further obtain a permission, for example, to send a message in the group.

For example, in some embodiments of the present disclosure, taking the user USR1 with the first member identity attribute IDP1 in the team A1 in the above example as an example, after an association relationship between the team A1 and the group B4 is established, the user USR1 may select whether to join the group B4 to become a group member of the group B4. For example, when the user USR1 selects to join the group B4, the user USR1 will also be granted the fifth member identity attribute IDP5 associated with the group B4 in the team A1.

For example, in some embodiments of the present disclosure, taking the user USR5 with the fifth member identity attribute IDP5 associated with the group B4 in the team A1 in the above example as an example, after an association relationship between the team A1 and the group B4 is established, the user USR5 may, for example, select whether to join the group B1 (or the group B2 or B3) to become a group member of the group B1. For example, when the user USR5 selects to join the group B1, the user USR5 will also be granted the second member identity attribute IDP2 associated with the group B1 in the team A1.

For example, in some embodiments of the present disclosure, taking the user USR5 with the fifth member identity attribute IDP5 associated with the group B4 in the team A1 in the above example as an example, when the user USR5 is removed from the group B4, that is, the user USR5 is no longer a group member of the group B4, the user USR5 will no longer have the fifth member identity attribute IDP5 associated with the group B4 in the team A1. For example, in the case that the user USR5 does not have any other member identity attribute in the team A1, the user USR5 is no longer a team member of the team A1. For another example, in the case that the user USR5 also has an other member identity attribute in the team A1, the other member identity attribute of the user USR5 in the team A1 is maintained, and since the user USR5 still has the other member identity attribute in the team A1, the user USR5 is still a team member of the team A1.

For example, in some embodiments of the present disclosure, taking the user USR5 with the fifth member identity attribute IDP5 associated with the group B4 in the team A1 in the above example as an example, when the user USR5 is removed from the team A1, that is, the user USR5 is no longer a team member of the team A1, all member identity attributes of the user USR5 in the team A1 are deleted, and the user USR5 still remains as a group member of the group B4.

For example, in some embodiments of the present disclosure, taking the user USR5 with the fifth member identity attribute IDP5 associated with the group B4 in the team A1 in the above example as an example, when the association relationship between the team A1 and the group B4 is released, the team A1 and the group B4 are respectively maintained, and the fifth member identity attribute IDP5 associated with the group B4 of the user USR5 in the team A1 is deleted. For example, the user USR5 still remains as a group member of the group B4. For example, in the case that the user USR5 does not have any other member identity attribute in the team A1, the user USR5 is no longer a team member of the team A1; or in the case that the user USR5 also has an other member identity attribute in the team A1, the other member identity attribute of the user USR5 in the team A1 is maintained, and since the user USR5 still has the other member identity attribute in the team A1, the user USR5 is still a team member of the team A1.

For example, in some embodiments of the present disclosure, for the above Step SP10 and Step SP20, when the association relationship between the first object set and the second object set is established, a plurality of member objects in the second object set may be selected to be added to the first object set (certainly, in other embodiments, it may also be selected not to add member objects in the second object set to the first object set), for example, some or all member objects in the second object set are added to the first object set. Therefore, the some or all member objects of the second object set that are originally not included in the first object set (that is, originally not member objects of the first object set) may be added to the first object set through the second object set to become member objects of the first object set, thereby facilitating quick batch adding processing of member objects in the first object set, and further facilitating flexible management of the member objects in the first object set.

For example, in some embodiments of the present disclosure, when the association relationship between the first object set and the second object set is released, the second member identity attribute of the plurality of member objects with the second member identity attribute associated with the second object set in the first object set may be deleted at the same time, and for example, when a user does not have any member identity attribute in the first object set, the user is no longer a member object of the first object set, that is, the user is not included in the first object set, thereby facilitating quick batch removal processing of the member objects in the first object set, and further facilitating flexible management of the member objects in the first object set.

For example, in some embodiments of the present disclosure, one first object set is allowed to have an association relationship with one or more second object sets, and one second object set is allowed to have an association relationship with one or more first object sets. For example, taking the team and the group in the above application example as an example, one team may have an association relationship with a plurality of groups, for example, the plurality of groups are subordinate to the team or referenced by the team; and one group may have an association relationship with a plurality of teams, for example, one group may be referenced by a plurality of teams at the same time.

For example, in some embodiments of the present disclosure, before and after an association relationship between the first object set and the second object set changes, for example, the association relationship is a reference relationship, an independent operation permission of the second object set relative to the first object set remains consistent.

For example, the independent operation permission may include an independent operation permission that can be executed by the second object set for operations such as information (or data) transmission and information (or data) exchange in the second object set. For example, management permission, control permission, or operation permission of the second object set for information transmission and information exchange in the second object set is not limited to the first object set. Before and after the association relationship between the first object set and the second object set changes, information transmission, information exchange, and the like in the second object set are all independently managed by the second object set, and the first object set does not have management permission for such as information transmission and information exchange in the second object set.

For example, the independent operation permission may further include an independent operation permission that can be executed by the second object set for each member object of the second object set. For example, before and after an association relationship between the first object set and the second object set changes, for example, the association relationship is a reference relationship, a change of member objects of the second object set is independently managed by the second object set, and the first object set does not have an operation permission to change the member objects of the second object set.

For example, in the case that the association relationship between the first object set and the second object set is a reference relationship, an increase/decrease operation of member objects of the second object set may be independent of an increase/decrease operation of member objects of the first object set. That is, an operation permission of the second object set for an increase/decrease operation of the member objects of the second object set is not limited to the first object set, and an operation permission of the first object set for an increase/decrease operation of the member objects of the first object set is not limited to the second object set. For example, the increase/decrease operation of the member objects of the first object set may be independently managed by the first object set, and the increase/decrease operation of the member objects of the second object set may be independently managed by the second object set.

When member objects of the first object set change, member objects of the second object set do not change. For example, when a new member object is added to the first object set, the second object set does not need to add the member object, or whether the new member object needs to be added to the second object set is determined or managed by the second object set; and when a member object exits from the first object set, the member object does not need to exit from the second object set, or whether the member object needs to exit from the second object set is determined or managed by the second object set.

When member objects of the second object set change, member objects of the first object set do not change. For example, when a new member object is added to the second object set, the first object set does not need to add the member object, or whether the new member object needs to be added to the first object set is determined or managed by the first object set; and when a member object exits from the second object set, the member object does not need to exit from the first object set, or whether the member object needs to exit from the first object set is determined or managed by the first object set.

For example, in some embodiments of the present disclosure, before and after an association relationship between the first object set and the second object set changes, for example, the association relationship is a reference relationship, an operation permission of each member object of the second object set to the second object set remains consistent all the time. For example, an information access permission, an information transmission permission, an information exchange permission, and the like of each member object of the second object set to the second object set are not affected by the change of the association relationship between the first object set and the second object set, and are also not limited to the first object set.

For example, taking an example in which before an association relationship between the first object set and the second object set is established, member objects of the first object set include a first user, and member objects of the second object set do not include the first user, that is, before the association relationship between the first object set and the second object set is established, the first user is a member object of the first object set but is not a member object of the second object set, after the association relationship between the first object set and the second object set is established, the first user may be allowed to consult information transmission or information exchange in the second object set, perform information transmission or information exchange in the second object set, consult member information about a member object of the second object set, or perform individual information exchange with a specific member object of the second object set.

For another example, taking an example in which before an association relationship between the first object set and the second object set is established, member objects of the first object set include a first user, and member objects of the second object set do not include the first user, that is, before the association relationship between the first object set and the second object set is established, the first user is a member object of the first object set but is not a member object of the second object set, after the association relationship between the first object set and the second object set is established, the first user may be selected to be added as a member object of the second object set. That is, after the association relationship between the first object set and the second object set is established, the first user that is originally not a member object of the second object set is added to the second object set as a new member object of the second object set.

For example, the “member object of the first object set” mentioned in some embodiments of the present disclosure may be understood as a user or a user member of the first object set, that is, a “first user set” or a “user of the first user set,” and the “member object of the second object set” may be understood as a user or a user member of the second object set, that is, a “second user set” or a “user of the second user set.”

For example, in some examples, the “first object set” may be represented or understood as a “team,” an “organization,” a “group,” or a “set” including a plurality of users, and the “second object set” may be represented or understood as a “group” or a “set” including a plurality of users, for example, a chat group for instant messaging in which a plurality of users perform information exchange in the group, such as exchanging the text, picture, voice, video, network link, and the like in the group.

For example, in some embodiments of the present disclosure, the first object set itself may not have a function of implementing information exchange. Therefore, the member object of the first object set cannot directly perform information exchange in a form of the first object set, but needs to implement information exchange through, for example, a second object set being associated with the first object set and having an information exchange function.

It should be noted that in some other embodiments of the present disclosure, in the case that the first object set itself does not have a function of implementing information exchange, and the first object set has only one second object set associated with the first object set, the first object set may, for example, not directly provide an information exchange function to the member object of the first object set, but enables the member object of the first object set to perform information exchange through the second object set, so that the first object set indirectly has a function or effect of providing information exchange. Furthermore, member objects of the second object set need to be the same as member objects of the first object set, to meet requirements of enabling all member objects of the first object set to perform information exchange in a form of the one second object set.

For example, in some embodiments of the present disclosure, in the case that there is an association relationship (for example, a reference relationship or a subordination relationship) between the second object set and the first object set, when the first object set is disbanded, the association relationship between the first object set and the second object set is released, and the second object set is maintained.

For example, in the case that the first object set is disbanded, since the first object set no longer exists after being disbanded, the association relationship between the first object set and the second object set also needs to be released while the first object set is disbanded. Furthermore, since the release of the association relationship does not affect an existence of the second object set itself, that is, the release of the association relationship or the disbanding of the first object set does not cause the disbanding of the second object set. Therefore, after the association relationship between the first object set and the second object set is released, the second object set still remains, for example, after the association relationship is released, the second object set may exist independently of the first object set.

For example, in some embodiments of the present disclosure, in the case that there is an association relationship (for example, a reference relationship or a subordination relationship) between the second object set and the first object set, when the second object set is disbanded, the association relationship between the first object set and the second object set is released, and the first object set is maintained.

For example, in the case that the second object set is disbanded, since the second object set no longer exists after being disbanded, the association relationship between the first object set and the second object set also needs to be released while the second object set is disbanded. Furthermore, since the release of the association relationship does not affect an existence of the first object set itself, that is, the release of the association relationship or the disbanding of the second object set does not cause the disbanding of the first object set. Therefore, after the association relationship between the first object set and the second object set is released, the first object set still remains, for example, after the association relationship is released, the first object set may exist independently of the second object set.

At least one embodiment of the present disclosure further provides an interaction method, and the interaction method includes: obtaining a trigger operation for a first object set, an association relationship being present between the first object set and a second object set, a member object of the first object set having a first member identity attribute and/or a second member identity attribute, and the first member identity attribute being different from the second member identity attribute; and in response to the trigger operation, presenting member identity attribute information of the member object of the first object set.

In at least one example of the interaction method provided by the above embodiment of the present disclosure, the member identity attribute information of the member object of the first object set may be presented in the case that member objects of the first object set have different member identity attributes such as the first member identity attribute or the second member identity attribute, thereby facilitating flexible management of the member objects in the first object set. For example, in some examples, quick batch change processing of the member objects in the first object set may also be facilitated.

FIG. 18 is a schematic flowchart of still another interaction method provided by some embodiments of the present disclosure.

As shown in FIG. 18, the interaction method provided by the embodiments of the present disclosure includes Step SP11 and Step SP12.

Step SP11: obtaining a trigger operation for a first object set, an association relationship being present between the first object set and a second object set, a member object of the first object set having a first member identity attribute and/or a second member identity attribute, and the first member identity attribute being different from the second member identity attribute.

Step SP12: in response to the trigger operation, presenting member identity attribute information of the member object of the first object set.

For example, in some embodiments of the present disclosure, for the above Step SP11 and Step SP12, the first member identity attribute is not associated with the second object set, and the second member identity attribute is associated with the second object set.

For example, in some embodiments of the present disclosure, presenting the member identity attribute information of the member object of the first object set in the above Step SP 11 includes: presenting, in a first display style, member identity attribute information of the member object of the first object set that has the first member identity attribute, and presenting, in a second display style different from the first display style, member identity attribute information of the member object of the first object set that has the second member identity attribute.

For example, in some embodiments of the present disclosure, for the member object of the first object set that is added to the first object set through the second object set, the second member identity attribute is granted to the member object in the first object set; and for the member object of the first object set that is not added to the first object set through any object set, the first member identity attribute is granted to the member object in the first object set.

It should be noted that, in the embodiments of the present disclosure, a process of the interaction method provided in each of the above embodiments of the present disclosure may include more or fewer operations, and these operations may be performed sequentially or in parallel. Although the process of the interaction method described above includes a plurality of operations that occur in a specific order, it should be clearly understood that the order of the plurality of operations is not limited. The interaction method described above may be performed once, or may be performed multiple times according to a predetermined condition.

At least one embodiment of the present disclosure further provides an interaction apparatus, and the interaction apparatus includes an association relationship change request obtaining unit, an association relationship establishing unit, and an association relationship release unit; the association relationship change request obtaining unit is configured to obtain a first change request for changing an association relationship between a first object set and a second object set, a member of the first object set is allowed to include an individual member and a set member, a member of the second object set includes an individual member, the individual member is one member object, and the set member is a member object set including at least one member object; the association relationship establishing unit is configured to establish, in response to the first change request, a first association relationship between the second object set and the first object set, and add the second object set as the set member to the first object set; and the association relationship release unit is configured to release, in response to the first change request, the first association relationship between the second object set and the first object set, and remove the second object set as the set member from the first object set.

In at least one example of the interaction apparatus provided by the above embodiment of the present disclosure, in the case that the first object set has the association relationship with the second object set, the second object set serves as one set member of the first object set. Therefore, when the association relationship between the first object set and the second object set changes, it may help to implement quick batch change processing on the member objects in the first object set, thereby facilitating implementing flexible management of the member objects in the first object set.

FIG. 19 is a schematic block diagram of an interaction apparatus provided by some embodiments of the present disclosure.

For example, as shown in FIG. 19, the interaction apparatus 600 includes an association relationship change request obtaining unit 601, an association relationship establishing unit 602, and an association relationship release unit 603.

The association relationship change request obtaining unit 601 is configured to obtain a first change request for changing an association relationship between a first object set and a second object set, a member of the first object set is allowed to include an individual member and a set member, a member of the second object set includes an individual member, the individual member is one member object, and the set member is a member object set including at least one member object. For example, the association relationship change request obtaining unit 601 may perform Step S10 in the interaction method shown in FIG. 2.

The association relationship establishing unit 602 is configured to establish, in response to the first change request, a first association relationship between the second object set and the first object set, and add the second object set as the set member to the first object set. For example, the association relationship establishing unit 602 may perform Step S20 in the interaction method shown in FIG. 2.

The association relationship release unit 603 is configured to release, in response to the first change request, the first association relationship between the second object set and the first object set, and remove the second object set as the set member from the first object set. For example, the association relationship release unit 603 may perform Step S20 in the interaction method shown in FIG. 2.

For example, the association relationship change request obtaining unit 601, the association relationship establishing unit 602, and the association relationship release unit 603 include the code and program stored in a memory; and a processor may execute the code and program to implement some or all functions of the association relationship change request obtaining unit 601, the association relationship establishing unit 602, and the association relationship release unit 603 as described above. For example, the association relationship change request obtaining unit 601, the association relationship establishing unit 602, and the association relationship release unit 603 may be dedicated hardware devices, and are configured to implement some or all functions of the association relationship change request obtaining unit 601, the association relationship establishing unit 602, and the association relationship release unit 603 as described above. For example, the association relationship change request obtaining unit 601, the association relationship establishing unit 602, and the association relationship release unit 603 may be a circuit board or a combination of a plurality of circuit boards, and are configured to implement the functions as described above. In the embodiments of the present disclosure, the circuit board or the combination of the plurality of circuit boards may include: (1) one or more processors; (2) one or more non-transitory memories connected to the processor; and (3) firmware that is executable by the processor and stored in the memory.

It should be noted that specific descriptions of the association relationship change request obtaining unit 601, the association relationship establishing unit 602, and the association relationship release unit 603 may respectively refer to the related descriptions corresponding to Step S10 and Step S20 shown in FIG. 2 in the embodiments of the above interaction method. In addition, the interaction apparatus may implement similar technical effects to those of the foregoing interaction method, and details are not described herein again.

At least one embodiment of the present disclosure further provides an interaction apparatus, and the interaction apparatus includes a trigger operation obtaining unit and an information presentation unit; the trigger operation obtaining unit is configured to obtain a first trigger operation for a first object set, a member of the first object set includes an individual member and a set member, the individual member is a single member object, and the set member is a member object set including at least one member object; and the information presentation unit is configured to present, in response to the first trigger operation, individual member information and set member information of the first object set.

In at least one example of the interaction apparatus provided by the above embodiment of the present disclosure, the individual member information and the set member information of the first object set may be displayed in the case that the member of the first object set includes the individual member and the set member, thereby facilitating flexible management of member objects in the first object set and quick batch change processing of member objects in the first object set.

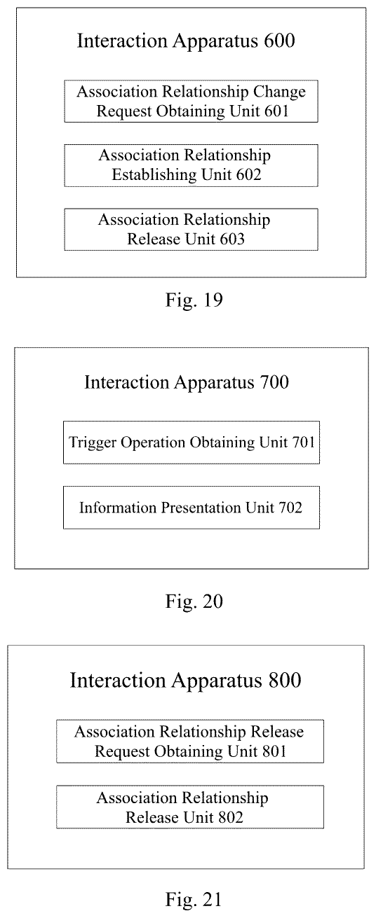

FIG. 20 is a schematic block diagram of another interaction apparatus provided by some embodiments of the present disclosure.

For example, as shown in FIG. 20, the interaction apparatus 700 includes a trigger operation obtaining unit 701 and an information presentation unit 702.

The trigger operation obtaining unit 701 is configured to obtain a first trigger operation for a first object set, a member of the first object set includes an individual member and a set member, the individual member is a single member object, and the set member is a member object set including at least one member object. For example, the trigger operation obtaining unit 701 may perform Step S21 in the interaction method shown in FIG. 9.

The information presentation unit 702 is configured to present, in response to the first trigger operation, individual member information and set member information of the first object set. For example, the information presentation unit 702 may perform Step S22 in the interaction method shown in FIG. 9.

For example, the trigger operation obtaining unit 701 and the information presentation unit 702 include the code and program stored in a memory; and a processor may execute the code and program to implement some or all functions of the trigger operation obtaining unit 701 and the information presentation unit 702 as described above. For example, the trigger operation obtaining unit 701 and the information presentation unit 702 may be dedicated hardware devices, and are configured to implement some or all functions of the trigger operation obtaining unit 701 and the information presentation unit 702 as described above. For example, the trigger operation obtaining unit 701 and the information presentation unit 702 may be a circuit board or a combination of a plurality of circuit boards, and are configured to implement the functions as described above. In the embodiments of the present disclosure, the circuit board or the combination of the plurality of circuit boards may include: (1) one or more processors; (2) one or more non-transitory memories connected to the processor; and (3) firmware that is executable by the processor and stored in the memory.

It should be noted that specific descriptions of the trigger operation obtaining unit 701 and the information presentation unit 702 may respectively refer to the related descriptions corresponding to Step S21 and Step S22 shown in FIG. 9 in the embodiments of the above interaction method. In addition, the interaction apparatus may implement similar technical effects to those of the foregoing interaction method, and details are not described herein again.

At least one embodiment of the present disclosure further provides an interaction apparatus, and the interaction apparatus includes an association relationship release request obtaining unit and an association relationship release unit; the association relationship release request obtaining unit is configured to obtain a relationship release request for releasing an association relationship between a first object set and a second object set, a member of the first object set is allowed to include an individual member and a set member, a member of the second object set includes an individual member, the individual member is one member object, the set member is a member object set including at least one member object, and the second object set is the set member of the first object set; and the association relationship release unit is configured to, in response to the relationship release request, release the association relationship between the second object set and the first object set, and remove the second object set as the set member from the first object set.

In at least one example of the interaction apparatus provided by the above embodiment of the present disclosure, the second object set that is a set member of the first object set may be removed from the first object set, that is, the second object set no longer has the association relationship with the first object set, and the second object set is no longer the set member of the first object set. For example, taking member objects that join the first object set through the second object set and are not originally included in the first object set (that is, are not originally member objects of the first object set) as an example, these member objects are also removed from the first object set as a whole and are no longer member objects of the first object set, so that quick batch removal processing of the member objects in the first object set may be facilitated. Therefore, flexible management of the member objects in the first object set may be facilitated.

FIG. 21 is a schematic block diagram of still another interaction apparatus provided by some embodiments of the present disclosure.

For example, as shown in FIG. 21, the interaction apparatus 800 includes an association relationship release request obtaining unit 801 and an association relationship release unit 802.

The association relationship release request obtaining unit 801 is configured to obtain a relationship release request for releasing an association relationship between a first object set and a second object set, a member of the first object set is allowed to include an individual member and a set member, a member of the second object set includes an individual member, the individual member is one member object, the set member is a member object set including at least one member object, and the second object set is the set member of the first object set. For example, the association relationship release request obtaining unit 801 may perform Step S31 in the interaction method shown in FIG. 10.

The association relationship release unit 802 is configured to, in response to the relationship release request, release the association relationship between the second object set and the first object set, and remove the second object set as the set member from the first object set. For example, the association relationship release unit 802 may perform Step S32 in the interaction method shown in FIG. 10.

For example, the association relationship release request obtaining unit 801 and the association relationship release unit 802 include the code and program stored in a memory; and a processor may execute the code and program to implement some or all functions of the association relationship release request obtaining unit 801 and the association relationship release unit 802 as described above. For example, the association relationship release request obtaining unit 801 and the association relationship release unit 802 may be dedicated hardware devices, and are configured to implement some or all functions of the association relationship release request obtaining unit 801 and the association relationship release unit 802 as described above. For example, the association relationship release request obtaining unit 801 and the association relationship release unit 802 may be a circuit board or a combination of a plurality of circuit boards, and are configured to implement the functions as described above. In the embodiments of the present disclosure, the circuit board or the combination of the plurality of circuit boards may include: (1) one or more processors; (2) one or more non-transitory memories connected to the processor; and (3) firmware that is executable by the processor and stored in the memory.

It should be noted that specific descriptions of the association relationship release request obtaining unit 801 and the association relationship release unit 802 may respectively refer to the related descriptions corresponding to Step S31 and Step S32 shown in FIG. 10 in the embodiments of the above interaction method. In addition, the interaction apparatus may implement similar technical effects to those of the foregoing interaction method, and details are not described herein again.

At least one embodiment of the present disclosure further provides an interaction apparatus, and the interaction apparatus includes a member adding request obtaining unit and a member adding request response unit; the member adding request obtaining unit is configured to obtain a first member adding request or a second member adding request for adding a user to a first object set, an association relationship is present between the first object set and a second object set, and the second member adding request is a request for adding the user to the first object set through the second object set when the user is a member object of the second object set; and the member adding request response unit is configured to: in response to the first member adding request, add the user to the first object set to enable the user to become a member object of the first object set, and grant a first member identity attribute to the user in the first object set, or in response to the second member adding request, add the user to the first object set through the second object set, to enable the user to become a member object of the first object set, and grant a second member identity attribute to the user in the first object set, the second member identity attribute being associated with the second object set.

In at least one example of the interaction apparatus provided by the above embodiment of the present disclosure, the user may be added to the first object set in different manners in response to the first member adding request and the second member adding request which are different, respectively, so that the user joining the first object set in different manners may have different member identity attributes in the first object set, thereby facilitating flexible management of the member object in the first object set.

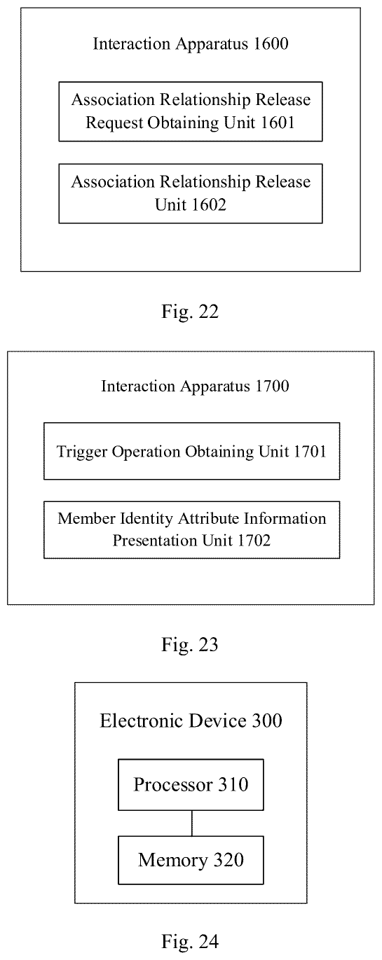

FIG. 22 is a schematic block diagram of still another interaction apparatus provided by some embodiments of the present disclosure.

For example, as shown in FIG. 22, the interaction apparatus 1600 includes a member adding request obtaining unit 1601 and a member adding request response unit 1602.

The member adding request obtaining unit 1601 is configured to obtain a first member adding request or a second member adding request for adding a user to a first object set, an association relationship is present between the first object set and a second object set, and the second member adding request is a request for adding the user to the first object set through the second object set when the user is a member object of the second object set. For example, the member adding request obtaining unit 1601 may perform Step SP10 in the interaction method shown in FIG. 11.

The member adding request response unit 1602 is configured to: in response to the first member adding request, add the user to the first object set to enable the user to become a member object of the first object set, and grant a first member identity attribute to the user in the first object set, or in response to the second member adding request, add the user to the first object set through the second object set, to enable the user to become a member object of the first object set, and grant a second member identity attribute to the user in the first object set, the second member identity attribute being associated with the second object set. For example, the member adding request response unit 1602 may perform Step SP20 in the interaction method shown in FIG. 11.

For example, the member adding request obtaining unit 1601 and the member adding request response unit 1602 include the code and program stored in a memory; and a processor may execute the code and program to implement some or all functions of the member adding request obtaining unit 1601 and the member adding request response unit 1602 as described above. For example, the member adding request obtaining unit 1601 and the member adding request response unit 1602 may be dedicated hardware devices, and are configured to implement some or all functions of the member adding request obtaining unit 1601 and the member adding request response unit 1602 as described above. For example, the member adding request obtaining unit 1601 and the member adding request response unit 1602 may be a circuit board or a combination of a plurality of circuit boards, and are configured to implement the functions as described above. In the embodiments of the present disclosure, the circuit board or the combination of the plurality of circuit boards may include: (1) one or more processors; (2) one or more non-transitory memories connected to the processor; and (3) firmware that is executable by the processor and stored in the memory.

It should be noted that specific descriptions of the member adding request obtaining unit 1601 and the member adding request response unit 1602 may respectively refer to the related descriptions corresponding to Step SP10 and Step SP20 shown in FIG. 11 in the embodiments of the above interaction method. In addition, the interaction apparatus may implement similar technical effects to those of the foregoing interaction method, and details are not described herein again.

At least one embodiment of the present disclosure further provides an interaction apparatus, and the interaction apparatus includes a trigger operation obtaining unit and a member identity attribute information presentation unit; the trigger operation obtaining unit is configured to obtain a trigger operation for a first object set, an association relationship is present between the first object set and a second object set, a member object of the first object set has a first member identity attribute and/or a second member identity attribute, and the first member identity attribute is different from the second member identity attribute; and the member identity attribute information presentation unit is configured to, in response to the trigger operation, present member identity attribute information of the member object of the first object set.

In at least one example of the interaction apparatus provided by the above embodiment of the present disclosure, the member identity attribute information of the member object of the first object set may be presented in the case that member objects of the first object set have different member identity attributes such as the first member identity attribute or the second member identity attribute, thereby facilitating flexible management of the member objects in the first object set. For example, in some examples, quick batch change processing of the member objects in the first object set may also be facilitated.

FIG. 23 is a schematic block diagram of still another interaction apparatus provided by some embodiments of the present disclosure.

For example, as shown in FIG. 23, the interaction apparatus 1700 includes a trigger operation obtaining unit 1701 and a member identity attribute information presentation unit 1702.

The trigger operation obtaining unit 1701 is configured to obtain a trigger operation for a first object set, an association relationship is present between the first object set and a second object set, a member object of the first object set has a first member identity attribute and/or a second member identity attribute, and the first member identity attribute is different from the second member identity attribute. For example, the trigger operation obtaining unit 1701 may perform Step SP11 in the interaction method shown in FIG. 18.

The member identity attribute information presentation unit 1702 is configured to, in response to the trigger operation, present member identity attribute information of the member object of the first object set. For example, the member identity attribute information presentation unit 1702 may perform Step SP12 in the interaction method shown in FIG. 18.

For example, the trigger operation obtaining unit 1701 and the member identity attribute information presentation unit 1702 include the code and program stored in a memory; and a processor may execute the code and program to implement some or all functions of the trigger operation obtaining unit 1701 and the member identity attribute information presentation unit 1702 as described above. For example, the trigger operation obtaining unit 1701 and the member identity attribute information presentation unit 1702 may be dedicated hardware devices, and are configured to implement some or all functions of the trigger operation obtaining unit 1701 and the member identity attribute information presentation unit 1702 as described above. For example, the trigger operation obtaining unit 1701 and the member identity attribute information presentation unit 1702 may be a circuit board or a combination of a plurality of circuit boards, and are configured to implement the functions as described above. In the embodiments of the present disclosure, the circuit board or the combination of the plurality of circuit boards may include: (1) one or more processors; (2) one or more non-transitory memories connected to the processor; and (3) firmware that is executable by the processor and stored in the memory.

It should be noted that specific descriptions of the trigger operation obtaining unit 1701 and the member identity attribute information presentation unit 1702 may respectively refer to the related descriptions corresponding to Step SP11 and Step SP12 shown in FIG. 18 in the embodiments of the above interaction method. In addition, the interaction apparatus may implement similar technical effects to those of the foregoing interaction method, and details are not described herein again.

At least one embodiment of the present disclosure further provides an electronic device, and the electronic device includes a processor and a memory. The memory includes one or more computer-executable instructions. The one or more computer-executable instructions are stored in the memory and configured to be executed by the processor, and the one or more computer-executable instructions are configured to implement the interaction method provided by any one of the embodiments of the present disclosure.

FIG. 24 is a schematic block diagram of an electronic device provided by some embodiments of the present disclosure. As shown in FIG. 24, the electronic device 300 includes a processor 310 and a memory 320, and may be configured to implement a client or a server. The memory 320 is configured to store, in a non-transitory manner, computer-executable instructions (for example, one or more computer program modules). The processor 310 is configured to run the computer-executable instructions. The computer-executable instructions, when executed by the processor 310, cause the processor 310 to perform one or more steps in the interaction method described above, thereby implementing the interaction method described above. The memory 320 and the processor 310 may be interconnected by a bus system and/or other forms of connection mechanism (not shown).

For example, the processor 310 may be a central processing unit (CPU), a graphics processing unit (GPU), or a processing unit in other form having data processing capability and/or program executing capability. For example, the CPU may be an X86 or ARM architecture, or the like. The processor 310 may be a general purpose processor or a special purpose processor, and may control other components in the electronic device 300 to perform desired functions.

For example, the memory 320 may include any combination of one or more computer program products, and the computer program products may include various forms of computer-readable storage media, for example, a volatile memory and/or a non-volatile memory. The volatile memory may include, for example, a random access memory (RAM) and/or a cache, or the like. The non-volatile memory may include, for example, a read only memory (ROM), a hard disk, an erasable programmable read only memory (EPROM), a portable compact disk read only memory (CD-ROM), a USB memory, a flash memory, or the like. One or more computer program modules may be stored on the computer-readable storage medium, and the processor 310 may run the one or more computer program modules, to implement various functions of the electronic device 300. Various applications and various data, as well as various data used and/or generated by the applications may also be stored on the computer-readable storage medium.

It should be noted that, in the embodiments of the present disclosure, the specific functions and technical effects of the electronic device 300 may be with reference to the above description regarding the interaction method, which will not be described here redundantly.

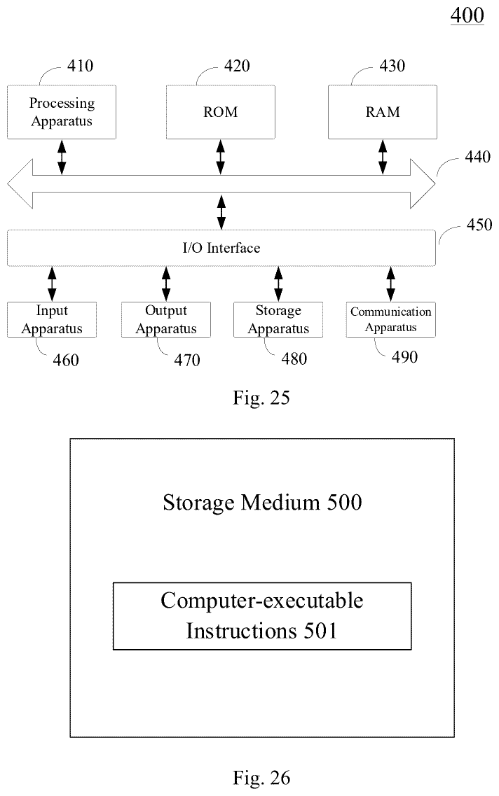

FIG. 25 is a schematic block diagram of another electronic device provided by some embodiments of the present disclosure. The electronic device 400 is, for example, applicable to implementing the interaction method provided by the embodiments of the present disclosure. The electronic device 400 may be a terminal device or the like, and may be configured to implement a client or a server. The electronic device 400 may include but not be limited to mobile terminals, such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device, etc., and fixed terminals, such as a digital TV, a desktop computer, a smart home device, etc. It should be noted that the electronic device 400 shown in FIG. 25 is merely an example and will not impose any limitations on the function and the range of use of the embodiments of the present disclosure.

As illustrated in FIG. 25, the electronic device 400 may include a processing apparatus 410 (e.g., a central processing unit, a graphics processing unit, etc.), which may execute various appropriate actions and processing according to a program stored on a read-only memory (ROM) 420 or a program loaded from a storage apparatus 480 into a random access memory (RAM) 430. The random access memory (RAM) 430 further stores various programs and data required for operation of the electronic device 400. The processing apparatus 410, the ROM 420, and the RAM 430 are connected with each other through a bus 440. An input/output (I/O) interface 450 is also connected to the bus 440.

Usually, apparatuses below may be connected to the I/O interface 450: an input apparatus 460 including, for example, a touch screen, a touch pad, a keyboard, a mouse, a camera, a microphone, an accelerometer, a gyroscope, or the like; an output apparatus 470 including, for example, a liquid crystal display (LCD), a speaker, a vibrator, or the like; a storage apparatus 480 including, for example, a magnetic tape, a hard disk, or the like; and a communication apparatus 490. The communication apparatus 490 may allow the electronic device 400 to perform wireless or wired communication with other electronic devices so as to exchange data. Although FIG. 25 shows the electronic device 400 having various apparatuses, it should be understood that, it is not required to implement or have all the apparatuses illustrated, and the electronic device 400 may alternatively implement or have more or fewer apparatuses.

For example, according to the embodiments of the present disclosure, the interaction method described above may be implemented as computer software programs. For example, the embodiments of the present disclosure include a computer program product, including a computer program carried on a non-transitory computer-readable medium, and the computer program includes program codes for executing the interaction method as described above. In such embodiments, the computer program may be downloaded and installed from the network via the communication apparatus 490, or installed from the storage apparatus 480, or installed from the ROM 420. When executed by the processing apparatus 410, the computer program may implement the functions defined in the interaction method provided by the embodiments of the present disclosure.

FIG. 26 is a schematic diagram of a storage medium provided by some embodiments of the present disclosure. For example, as illustrated in FIG. 26, the storage medium 500 may be a non-transitory computer-readable storage medium, which is configured to store non-transitory computer-executable instructions 501. When executed by the processor, the non-transitory computer-executable instructions 501 may implement the interaction method according to the embodiments of the present disclosure. For example, when executed by the processor, the non-transitory computer-executable instructions 501 may execute one or more steps of the interaction method described above.

For example, the storage medium 500 may be applied to the above-described electronic device. For example, the storage medium 500 may include a memory in the electronic device.

For example, the storage medium may include a memory card of a smart phone, a storage component of a tablet computer, a hard disk of a personal computer, a random access memory (RAM), a read-only memory (ROM), an erasable programmable read-only memory (EPROM), a portable compact disc read-only memory (CD-ROM), a flash memory, or any combination of the above-described storage media, or other applicable storage media.

For example, the illustration of the storage medium 500 may be with reference to the description of the memory in the embodiments of the electronic device, and details will not be repeated here. The specific functions and technical effects of the storage medium 500 may be with reference to the above description regarding the interaction method, which will not be described here redundantly.

It should be noted that, in the context of the present disclosure, the computer-readable medium may be a tangible medium that may contain or store programs for use by an instruction execution system, an apparatus, or a device, or for use in combination with an instruction execution system, an apparatus, or a device. The computer-readable medium may be a computer-readable signal medium or a computer-readable storage medium, or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program codes contained on the computer-readable medium may be transmitted by using any suitable medium, including but not limited to an electric wire, a fiber-optic cable, radio frequency (RF) and the like, or any appropriate combination of them.

In some implementations, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-described computer-readable medium may be included in the above-described electronic device, or may also exist alone without being assembled into the electronic device.

The computer program codes for performing the operations of the present disclosure may be written in one or more programming languages or a combination thereof. The above-described programming languages include but are not limited to object-oriented programming languages, such as Java, Smalltalk, C++, and also include conventional procedural programming languages, such as the “C” programming language or similar programming languages. The program codes may by executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flow chart and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of the unit does not constitute a limitation on the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

According to one or more embodiments of the present disclosure, an interaction method, comprising: obtaining a first change request for changing an association relationship between a first object set and a second object set, wherein a member of the first object set is allowed to comprise an individual member and a set member, a member of the second object set comprises an individual member, the individual member is one member object, and the set member is a member object set comprising at least one member object; and in response to the first change request: establishing a first association relationship between the second object set and the first object set, and adding the second object set as the set member to the first object set, or releasing the first association relationship between the second object set and the first object set, and removing the second object set as the set member from the first object set.

According to one or more embodiments of the present disclosure, the individual member of the first object set has an independent member identity attribute of the first object set, and the independent member identity attribute is not associated with any set member; and/or the set member of the first object set has a set member identity attribute of the first object set, at least one member object comprised in the set member of the first object set has a set-dependent member identity attribute of the first object set, and the set-dependent member identity attribute is associated with a corresponding set member.

According to one or more embodiments of the present disclosure, a member object of the first object set having the independent member identity attribute and/or the set-dependent member identity attribute has information access permission to the first object set.

According to one or more embodiments of the present disclosure, in response to the second object set being the set member of the first object set, for the member object of the first object set: at least one member object of the first object set has information access permission to the second object set, or the second object set is visible to at least one member object of the first object set, and a member object, not being subordinate to the second object set, among member objects of the first object set does not have information access permission to the second object set.

According to one or more embodiments of the present disclosure, in a case that a user is the individual member of the first object set and is further a member object comprised in the set member of the first object set: the user has the independent member identity attribute of the first object set and the set-dependent member identity attribute of the first object set; or the user has the independent member identity attribute of the first object set but does not have the set-dependent member identity attribute of the first object set.

According to one or more embodiments of the present disclosure, adding the second object set as the set member to the first object set comprises: for one member object of the second object set, in response to the individual member of the first object set not comprising the one member object, granting the set-dependent member identity attribute of the first object set to the one member object, wherein the set-dependent member identity attribute is associated with the second object set; or in response to the individual member of the first object set already comprising the one member object, adding the set-dependent member identity attribute associated with the second object set to the one member object, or not adding the set-dependent member identity attribute associated with the second object set to the one member object.

According to one or more embodiments of the present disclosure, adding the second object set as the set member to the first object set comprises: granting the set-dependent member identity attribute of the first object set to a part of member objects of the second object set, and not granting the set-dependent member identity attribute of the first object set to another part of member objects of the second object set, wherein the set-dependent member identity attribute is associated with the second object set.

According to one or more embodiments of the present disclosure, removing the second object set as the set member from the first object set comprises: for each member object, in the second object set, having the set-dependent member identity attribute of the first object set, deleting, in the first object set, the set-dependent member identity attribute associated with the second object set from the member object.

According to one or more embodiments of the present disclosure, removing the second object set as the set member from the first object set comprises: for any member object of the second object set: in response to the member object not having the independent member identity attribute in the first object set and not having the set-dependent member identity attribute associated with another set member in the first object set, removing the member object from the first object set; or in response to the member object further having the independent member identity attribute in the first object set or further having the set-dependent member identity attribute associated with another set member in the first object set, keeping the member object still belonging to the first object set.

According to one or more embodiments of the present disclosure, the method further comprises: obtaining a member removing request for removing a first member object as the individual member from the first object set; and in response to the member removing request, deleting the independent member identity attribute of the first object set from the first member object, and in a case that the first member object further has the set-dependent member identity attribute of the first object set, deleting all set-dependent member identity attributes of the first member object.

According to one or more embodiments of the present disclosure, in response to the second object set being the set member of the first object set and the first member object being a member object of the second object set, the first member object is kept still belonging to the second object set.

According to one or more embodiments of the present disclosure, the method further comprises: obtaining a member adding request for adding a second member object as the individual member to the first object set; and in response to the member adding request, adding the second member object as the individual member to the first object set and granting the independent member identity attribute of the first object set to the second member object.

According to one or more embodiments of the present disclosure, in a case that the second object set is the set member of the first object set and the second member object is a member object of the second object set, the method further comprises: granting the set-dependent member identity attribute of the first object set to the second member object, wherein the set-dependent member identity attribute is associated with the second object set.

According to one or more embodiments of the present disclosure, in a case that the second object set is the set member of the first object set and the second object set comprises a third member object having the set-dependent member identity attribute of the first object set, the set-dependent member identity attribute being associated with the second object set, the method further comprises: obtaining a member removing request for removing the third member object from the second object set; and in response to the member removing request, deleting the set-dependent member identity attribute of the first object set from the third member object, and removing the third member object from the second object set.

According to one or more embodiments of the present disclosure, in a case that the third member object does not have any other member identity attribute in the first object set, the third member object is no longer a member object of the first object set; or in a case that the third member object further has another member identity attribute in the first object set, the third member object is still a member object of the first object set.

According to one or more embodiments of the present disclosure, in a case that the second object set is the set member of the first object set, the method further comprises: obtaining a member adding request for adding a fourth member object, which is the individual member of the first object set, to the second object set; and in response to the member adding request, adding the fourth member object to the second object set and granting the set-dependent member identity attribute of the first object set to the fourth member object, wherein the set-dependent member identity attribute is associated with the second object set.

According to one or more embodiments of the present disclosure, in a case that the second object set is the set member of the first object set, the method further comprises: obtaining a member adding request for adding a fifth member object to the second object set, wherein the fifth member object is not a member object of the first object set; and in response to the member adding request, adding the fifth member object to the second object set and granting the set-dependent member identity attribute of the first object set to the fifth member object, to add the fifth member object to the first object set, wherein the set-dependent member identity attribute is associated with the second object set.

According to one or more embodiments of the present disclosure, a member information management page is provided in the first object set, the member information management page is configured to present individual member information and set member information of the first object set, and the set member information provides information about member objects comprised in the set member.

According to one or more embodiments of the present disclosure, a dynamic information presentation page is provided in the first object set, and in response to releasing the first association relationship between the second object set and the first object set, the method further comprises: pushing, on the dynamic information presentation page, dynamic information about a part of member objects of the second object set as the set member quitting the first object set.

According to one or more embodiments of the present disclosure, in a case that the first object set and the second object set have the first association relationship, after the first association relationship between the first object set and the second object set is released, the first object set and the second object set are respectively kept.

According to one or more embodiments of the present disclosure, the method further comprises: obtaining a first set dismissal request for dismissing the first object set, and in response to the first set dismissal request, after the first association relationship between the first object set and the second object set is released, dismissing the first object set and keeping the second object set; or obtaining a second set dismissal request for dismissing the second object set, and in response to the second set dismissal request, after the first association relationship between the first object set and the second object set is released, dismissing the second object set and keeping the first object set.

According to one or more embodiments of the present disclosure, the method further comprises: obtaining a second change request for changing an association relationship between the first object set and a third object set, wherein a member of the third object set comprises an individual member; and in response to the second change request: establishing a second association relationship different from the first association relationship between the first object set and the third object set, to enable the third object set to be visible through the first object set to at least one member object of the first object set, or releasing the second association relationship between the first object set and the third object set, to make the third object set no longer visible through the first object set to the member object of the first object set.

According to one or more embodiments of the present disclosure, an independent operation permission of the second object set relative to the first object set remains consistent before and after the first association relationship between the first object set and the second object set is changed; and an independent operation permission of the third object set relative to the first object set becomes different before and after the second association relationship between the first object set and the third object set is changed.

According to one or more embodiments of the present disclosure, the method further comprises: obtaining an association relationship establishing request for establishing an association relationship between the first object set and a fourth object set; in response to the association relationship establishing request, providing a selection control for establishing the first association relationship or the second association relationship; and in response to a selection result based on the selection control, establishing the first association relationship or the second association relationship between the first object set and the fourth object set.

According to one or more embodiments of the present disclosure, the method further comprises: changing the first association relationship between the first object set and the second object set to the second association relationship; and/or changing the second association relationship between the first object set and the third object set to the first association relationship.

According to one or more embodiments of the present disclosure, a set type of the first object set is different from a set type of the second object set, or the set type of the first object set is identical to the set type of the second object set, wherein the first object set and the second object set respectively have a non-null user member set.

According to one or more embodiments of the present disclosure, the first object set is a team, and the second object set is a group; or the first object set and the second object set are both groups; or the first object set and the second object set are both teams.

According to one or more embodiments of the present disclosure, an interaction method, comprising: obtaining a first trigger operation for a first object set, wherein a member of the first object set comprises an individual member and a set member, the individual member is a single member object, and the set member is a member object set comprising at least one member object; and in response to the first trigger operation, presenting individual member information and set member information of the first object set.

According to one or more embodiments of the present disclosure, the set member information provides information about a member object comprised in the set member.

According to one or more embodiments of the present disclosure, in a case that the first object set is associated with at least one second object set and the second object set is the set member of the first object set, set member information about the second object set provides: information about a member object, which is comprised in the first object set, of the second object set; and information about a member object, which is not comprised in the first object set, of the second object set.

According to one or more embodiments of the present disclosure, the method further comprises: obtaining a relationship establishing request for establishing an association relationship between the first object set and a second object set, and in response to the relationship establishing request, establishing the association relationship between the first object set and the second object set, and adding the second object set as the set member to the first object set; and/or obtaining a relationship release request for releasing an association relationship between the first object set and a second object set which is the set member of the first object set, and in response to the relationship release request, releasing the association relationship between the first object set and the second object set, and removing the second object set as the set member from the first object set.

According to one or more embodiments of the present disclosure, an interaction method, comprising: obtaining a relationship release request for releasing an association relationship between a first object set and a second object set, wherein a member of the first object set is allowed to comprise an individual member and a set member, a member of the second object set comprises an individual member, the individual member is one member object, the set member is a member object set comprising at least one member object, and the second object set is the set member of the first object set; and in response to the relationship release request, releasing the association relationship between the second object set and the first object set, and removing the second object set as the set member from the first object set.

According to one or more embodiments of the present disclosure, in response to removing the second object set as the set member from the first object set, for one member object of the second object set: in a case that the individual member of the first object set comprises the one member object, the one member object is still comprised in the first object set as the individual member; or in a case that the individual member of the first object set does not comprise the one member object and the one member object is not comprised in any other object set that is as the set member of the first object set, the one member object is no longer the member object of the first object set.

According to one or more embodiments of the present disclosure, in response to removing the second object set as the set member from the first object set, a member object in the second object set that meets a preset condition is deleted from member objects of the first object set, wherein the member object in the second object set that meets the preset condition comprises: the member object not being the individual member of the first object set and not being comprised in any other object set that is as the set member of the first object set.

According to one or more embodiments of the present disclosure, an interaction method, comprising: obtaining a first member adding request or a second member adding request for adding a user to a first object set, wherein an association relationship is present between the first object set and a second object set, and the second member adding request is a request for adding the user to the first object set through the second object set when the user is a member object of the second object set; and in response to the first member adding request, adding the user to the first object set to enable the user to become a member object of the first object set, and granting a first member identity attribute to the user in the first object set, or in response to the second member adding request, adding the user to the first object set through the second object set, to enable the user to become a member object of the first object set, and granting a second member identity attribute to the user in the first object set, wherein the second member identity attribute is associated with the second object set.

According to one or more embodiments of the present disclosure, the member object of the first object set comprises a first user member; and in a case that the first user member is not the member object of the second object set and does not have the second member identity attribute associated with the second object set in the first object set: in the first object set, the second object set is not visible to the first user member, or the first user member does not have information access permission to access the second object set through the first object set.

According to one or more embodiments of the present disclosure, the member object of the first object set comprises a first user member; in a case that the first user member is not the member object of the second object set and does not have the second member identity attribute associated with the second object set in the first object set, the first user member has first information access permission to access the second object set through the first object set; and in a case that the first user member has the second member identity attribute associated with the second object set in the first object set, the first user member has second information access permission to access the second object set through the first object set, wherein the first information access permission is different from the second information access permission.

According to one or more embodiments of the present disclosure, the first information access permission is lower than the second information access permission.

According to one or more embodiments of the present disclosure, the information access permission to access the second object set through the first object set comprises: a read-write operation permission for information interaction in the second object set, or a read-only operation permission for information interaction in the second object set.

According to one or more embodiments of the present disclosure, the member object of the first object set comprises a second user member; in a case that the second user member has the first member identity attribute and does not have the second member identity attribute, the second user member has third information access permission, in the first object set, to information in the first object set; and in a case that the second user member has the second member identity attribute and does not have the first member identity attribute, the second user member has fourth information access permission, in the first object set, to information in the first object set, wherein the fourth information access permission is different from the third information access permission.

According to one or more embodiments of the present disclosure, the fourth information access permission is lower than the third information access permission.

According to one or more embodiments of the present disclosure, in the first object set, the information access permission of the member object of the first object set comprises at least one of: allowing to consult information interaction in the first object set, allowing to perform information interaction in the first object set, allowing to consult member information about the member object of the first object set, or allowing to perform separate information interaction with a specific member object of the first object set.

According to one or more embodiments of the present disclosure, the first object set has an association relationship with at least one object set respectively, and the first member identity attribute is not associated with any one of the at least one object set.

According to one or more embodiments of the present disclosure, an association relationship is present between the first object set and a third object set; in the first object set, for a member object added to the first object set through the third object set, the member object has a third member identity attribute associated with the third object set in the first object set; the member object of the first object set comprises a third user member, and the third user member is not a member object of the third object set and does not have the third member identity attribute in the first object set; in a case that the third user member has the first member identity attribute in the first object set, the third object set is visible to the third user member through the first object set; and in a case that the third user member does not have the first member identity attribute in the first object set, in the first object set, the third object set is not visible to the third user member, or the third user member does not have information access permission to access the third object set through the first object set.

According to one or more embodiments of the present disclosure, an association relationship is present between the first object set and a third object set; in the first object set, for a member object added to the first object set through the third object set, the member object has a third member identity attribute associated with the third object set in the first object set; the member object of the first object set comprises a third user member, and the third user member is not a member object of the third object set and does not have the third member identity attribute in the first object set; in a case that the third user member has the first member identity attribute in the first object set, the third user member has fifth information access permission to access the third object set through the first object set; and in a case that the third user member does not have the first member identity attribute in the first object set, the third user member has sixth information access permission to access the third object set through the first object set, wherein the sixth information access permission is lower than the fifth information access permission.

According to one or more embodiments of the present disclosure, the member object of the first object set comprises a fourth user member, and the fourth user member is a member object of the second object set and has the second member identity attribute in the first object set; in response to removing the fourth user member from the second object set, the fourth user member no longer has the second member identity attribute in the first object set; and in response to removing the fourth user member from the first object set, the fourth user member is still kept as the member object of the second object set.

According to one or more embodiments of the present disclosure, in response to removing the fourth user member from the second object set, in a case that the fourth user member does not have any other member identity attribute in the first object set, the fourth user member is no longer the member object of the first object set; or in response to removing the fourth user member from the second object set, in a case that the fourth user member further has another member identity attribute in the first object set, the another member identity attribute of the fourth user member in the first object set is kept.

According to one or more embodiments of the present disclosure, the member object of the first object set comprises a fourth user member, and the fourth user member is a member object of the second object set and has, in the first object set, the second member identity attribute associated with the second object set; and the interaction method further comprises: in response to a change request for releasing the association relationship between the first object set and the second object set, deleting the second member identity attribute from the fourth user member in the first object set, wherein in a case that the fourth user member does not have any other member identity attribute in the first object set, the fourth user member is no longer the member object of the first object set, or in a case that the fourth user member further has another member identity attribute in the first object set, the another member identity attribute of the fourth user member in the first object set is kept.

According to one or more embodiments of the present disclosure, the method further comprises: in response to a change request for releasing the association relationship between the first object set and the second object set, deleting the second member identity attribute from each member object in the first object set that has the second member identity attribute associated with the second object set, wherein in a case that the each member object no longer has any member identity attribute in the first object set, the each member object is no longer the member object of the first object set, or in a case that the each member object further has another member identity attribute in the first object set, the another member identity attribute of the each member object in the first object set is kept.

According to one or more embodiments of the present disclosure, the method further comprises: in response to a change request for establishing an association relationship between the first object set and a fourth object set, establishing the association relationship between the first object set and the fourth object set; and adding at least one member object of the fourth object set to the first object set through the fourth object set, to enable the at least one member object to become the member object of the first object set, and in the first object set, granting a fourth member identity attribute to the at least one member object, wherein the fourth member identity attribute is associated with the fourth object set.

According to one or more embodiments of the present disclosure, the method further comprises: in response to a request for deleting the first member identity attribute of one member object in the first object set, deleting the first member identity attribute of the one member object in the first object set, wherein in a case that the one member object no longer has any member identity attribute in the first object set, the one member object is no longer the member object of the first object set.

According to one or more embodiments of the present disclosure, the method further comprises: obtaining a member removing request for removing one member object from the first object set; and in response to the member removing request, deleting all member identity attributes of the one member object in the first object set.

According to one or more embodiments of the present disclosure, the member object of the first object set comprises a fifth user member, and the fifth user member is not a member object of the second object set and does not have the second member identity attribute in the first object set; and the interaction method further comprises: in response to a third member adding request for adding the fifth user member to the second object set, adding the fifth user member to the second object set, and in the first object set, granting the second member identity attribute to the fifth user member.

According to one or more embodiments of the present disclosure, the association relationship comprises a subordination relationship or a reference relationship.

According to one or more embodiments of the present disclosure, a set type of the first object set is different from a set type of the second object set, or the set type of the first object set is identical to the set type of the second object set, wherein the first object set and the second object set respectively have a non-null user member set.

According to one or more embodiments of the present disclosure, the first object set is a team, and the second object set is a group; or the first object set and the second object set are both groups; or the first object set and the second object set are both teams.

According to one or more embodiments of the present disclosure, an interaction method, comprising: obtaining a trigger operation for a first object set, wherein an association relationship is present between the first object set and a second object set, a member object of the first object set has a first member identity attribute and/or a second member identity attribute, and the first member identity attribute is different from the second member identity attribute; and in response to the trigger operation, presenting member identity attribute information of the member object of the first object set.

According to one or more embodiments of the present disclosure, the first member identity attribute is not associated with the second object set, and the second member identity attribute is associated with the second object set.

According to one or more embodiments of the present disclosure, presenting the member identity attribute information of the member object of the first object set comprises: presenting, in a first display style, member identity attribute information of the member object of the first object set that has the first member identity attribute; and presenting, in a second display style different from the first display style, member identity attribute information of the member object of the first object set that has the second member identity attribute.

According to one or more embodiments of the present disclosure, for the member object of the first object set that is added to the first object set through the second object set, the second member identity attribute is granted to the member object in the first object set; or for the member object of the first object set that is not added to the first object set through any object set, the first member identity attribute is granted to the member object in the first object set.

According to one or more embodiments of the present disclosure, an interaction apparatus, comprising: an association relationship change request obtaining unit, configured to obtain a first change request for changing an association relationship between a first object set and a second object set, wherein a member of the first object set is allowed to comprise an individual member and a set member, a member of the second object set comprises an individual member, the individual member is one member object, and the set member is a member object set comprising at least one member object; an association relationship establishing unit, configured to establish, in response to the first change request, a first association relationship between the second object set and the first object set, and add the second object set as the set member to the first object set; and an association relationship release unit, configured to release, in response to the first change request, the first association relationship between the second object set and the first object set, and remove the second object set as the set member from the first object set.

According to one or more embodiments of the present disclosure, an interaction apparatus, comprising: a trigger operation obtaining unit, configured to obtain a first trigger operation for a first object set, wherein a member of the first object set comprises an individual member and a set member, the individual member is a single member object, and the set member is a member object set comprising at least one member object; and an information presentation unit, configured to present, in response to the first trigger operation, individual member information and set member information of the first object set.

According to one or more embodiments of the present disclosure, an interaction apparatus, comprising: an association relationship release request obtaining unit, configured to obtain a relationship release request for releasing an association relationship between a first object set and a second object set, wherein a member of the first object set is allowed to comprise an individual member and a set member, a member of the second object set comprises an individual member, the individual member is one member object, the set member is a member object set comprising at least one member object, and the second object set is the set member of the first object set; and an association relationship release unit, configured to, in response to the relationship release request, release the association relationship between the second object set and the first object set, and remove the second object set as the set member from the first object set.

According to one or more embodiments of the present disclosure, an interaction apparatus, comprising: a member adding request obtaining unit, configured to obtain a first member adding request or a second member adding request for adding a user to a first object set, wherein an association relationship is present between the first object set and a second object set, and the second member adding request is a request for adding the user to the first object set through the second object set when the user is a member object of the second object set; and a member adding request response unit, configured to: in response to the first member adding request, add the user to the first object set to enable the user to become a member object of the first object set, and grant a first member identity attribute to the user in the first object set, or in response to the second member adding request, add the user to the first object set through the second object set, to enable the user to become a member object of the first object set, and grant a second member identity attribute to the user in the first object set, wherein the second member identity attribute is associated with the second object set.

According to one or more embodiments of the present disclosure, an interaction apparatus, comprising: a trigger operation obtaining unit, configured to obtain a trigger operation for a first object set, wherein an association relationship is present between the first object set and a second object set, a member object of the first object set has a first member identity attribute and/or a second member identity attribute, and the first member identity attribute is different from the second member identity attribute; and a member identity attribute information presentation unit, configured to, in response to the trigger operation, present member identity attribute information of the member object of the first object set.

According to one or more embodiments of the present disclosure, an electronic device, comprising: a processor; and a memory, comprising one or more computer-executable instructions, wherein the one or more computer-executable instructions are stored in the memory and configured to be executed by the processor, and the one or more computer-executable instructions are configured to implement the interaction method according to any one of the embodiments of the present disclosure.

According to one or more embodiments of the present disclosure, a storage medium, configured to store non-transitory computer-executable instructions, wherein the non-transitory computer-executable instructions, when executed by a processor, cause the processor to implement the interaction method according to any one of the embodiments of the present disclosure.

The foregoing descriptions are merely descriptions of the preferred embodiments of the present disclosure and the explanations of the technical principles involved. It should be understood by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the scope of the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method actions, it should be understood that the subject matter defined in the appended claims is not necessarily limited to the particular features and actions described above. Rather, the particular features and actions described above are merely exemplary forms for implementing the claims.

For the present disclosure, the following statements should be noted.
(1) The accompanying drawings related to the embodiment(s) of the present disclosure involve only the structure(s) in connection with the embodiment(s) of the present disclosure, and other structure(s) may refer to common design(s).
(2) In case of no conflict, the embodiments of the present disclosure and features in one embodiment or in different embodiments can be combined to obtain new embodiments.

What have been described above merely are specific implementations of the present disclosure, and the protection scope of the present disclosure is not limited thereto. The protection scope of the present disclosure should be based on the protection scope of the claims.

1. An interaction method, comprising:
obtaining a first change request for changing an association relationship between a first object set and a second object set, wherein a member of the first object set is allowed to comprise an individual member and a set member, a member of the second object set comprises an individual member, the individual member is one member object, and the set member is a member object set comprising at least one member object; and
in response to the first change request:
establishing a first association relationship between the second object set and the first object set, and adding the second object set as the set member to the first object set, or releasing the first association relationship between the second object set and the first object set, and removing the second object set as the set member from the first object set.

2. The interaction method according to claim 1, wherein at least one of followings is satisfied:
(a) the individual member of the first object set has an independent member identity attribute of the first object set, and the independent member identity attribute is not associated with any set member; or
(b) the set member of the first object set has a set member identity attribute of the first object set, at least one member object comprised in the set member of the first object set has a set-dependent member identity attribute of the first object set, and the set-dependent member identity attribute is associated with a corresponding set member.

3. The interaction method according to claim 2, wherein at least one of followings is satisfied:
a member object of the first object set having the independent member identity attribute has information access permission to the first object set, or
a member object of the first object set having the set-dependent member identity attribute has information access permission to the first object set.

4. (canceled)

5. The interaction method according to claim 2, wherein in a case that a user is the individual member of the first object set and is further a member object comprised in the set member of the first object set:
the user has the independent member identity attribute of the first object set and the set-dependent member identity attribute of the first object set; or
the user has the independent member identity attribute of the first object set but does not have the set-dependent member identity attribute of the first object set.

6. (canceled)

7. (canceled)

8. The interaction method according to claim 2, wherein removing the second object set as the set member from the first object set comprises:
for each member object, in the second object set, having the set-dependent member identity attribute of the first object set, deleting, in the first object set, the set-dependent member identity attribute associated with the second object set from the member object.

9. The interaction method according to claim 2, wherein removing the second object set as the set member from the first object set comprises:
for any member object of the second object set:
in response to the member object not having the independent member identity attribute in the first object set and not having the set-dependent member identity attribute associated with another set member in the first object set, removing the member object from the first object set; or
in response to the member object further having the independent member identity attribute in the first object set or further having the set-dependent member identity attribute associated with another set member in the first object set, keeping the member object still belonging to the first object set.

10. The interaction method according to claim 2, wherein the method further comprises:
obtaining a member removing request for removing a first member object as the individual member from the first object set; and
in response to the member removing request, deleting the independent member identity attribute of the first object set from the first member object, and in a case that the first member object further has the set-dependent member identity attribute of the first object set, deleting all set-dependent member identity attributes of the first member object.

11. (canceled)

12. The interaction method according to claim 2, further comprising:
obtaining a member adding request for adding a second member object as the individual member to the first object set; and
in response to the member adding request, adding the second member object as the individual member to the first object set and granting the independent member identity attribute of the first object set to the second member object.

13. (canceled)

14. The interaction method according to claim 2, wherein in a case that the second object set is the set member of the first object set and the second object set comprises a third member object having the set-dependent member identity attribute of the first object set, the set-dependent member identity attribute being associated with the second object set, the method further comprises:
obtaining a member removing request for removing the third member object from the second object set; and
in response to the member removing request, deleting the set-dependent member identity attribute of the first object set from the third member object, and removing the third member object from the second object set.

15.-17. (canceled)

18. The interaction method according to claim 1, wherein a member information management page is provided in the first object set, the member information management page is configured to present individual member information and set member information of the first object set, and the set member information provides information about member objects comprised in the set member.

19. The interaction method according to claim 1, wherein a dynamic information presentation page is provided in the first object set, and
in response to releasing the first association relationship between the second object set and the first object set, the method further comprises:
pushing, on the dynamic information presentation page, dynamic information about a part of member objects of the second object set as the set member quitting the first object set.

20. (canceled)

21. The interaction method according to claim 1, further comprising:
obtaining a first set dismissal request for dismissing the first object set, and in response to the first set dismissal request, after the first association relationship between the first object set and the second object set is released, dismissing the first object set and keeping the second object set; or
obtaining a second set dismissal request for dismissing the second object set, and in response to the second set dismissal request, after the first association relationship between the first object set and the second object set is released, dismissing the second object set and keeping the first object set.

22. The interaction method according to claim 1, further comprising:
obtaining a second change request for changing an association relationship between the first object set and a third object set, wherein a member of the third object set comprises an individual member; and
in response to the second change request:
establishing a second association relationship different from the first association relationship between the first object set and the third object set, to enable the third object set to be visible through the first object set to at least one member object of the first object set, or
releasing the second association relationship between the first object set and the third object set, to make the third object set no longer visible through the first object set to the member object of the first object set.

23.-26. (canceled)

27. The interaction method according to claim 1, wherein
the first object set is a team, and the second object set is a group; or
the first object set and the second object set are both groups; or
the first object set and the second object set are both teams.

28. An interaction method, comprising:
obtaining a first trigger operation for a first object set, wherein a member of the first object set comprises an individual member and a set member, the individual member is a single member object, and the set member is a member object set comprising at least one member object; and
in response to the first trigger operation, presenting individual member information and set member information of the first object set.

29. The interaction method according to claim 28, wherein the set member information provides information about a member object comprised in the set member.

30. The interaction method according to claim 28, or wherein in a case that the first object set is associated with at least one second object set and the second object set is the set member of the first object set, set member information about the second object set provides: information about a member object, which is comprised in the first object set, of the second object set; and information about a member object, which is not comprised in the first object set, of the second object set.

31.-34. (canceled)

35. An interaction method, comprising:
obtaining a first member adding request or a second member adding request for adding a user to a first object set, wherein an association relationship is present between the first object set and a second object set, and the second member adding request is a request for adding the user to the first object set through the second object set when the user is a member object of the second object set; and
in response to the first member adding request, adding the user to the first object set to enable the user to become a member object of the first object set, and granting a first member identity attribute to the user in the first object set, or
in response to the second member adding request, adding the user to the first object set through the second object set, to enable the user to become a member object of the first object set, and granting a second member identity attribute to the user in the first object set, wherein the second member identity attribute is associated with the second object set.

36.-65. (canceled)

66. An electronic device, comprising:
a processor; and
a memory, comprising one or more computer-executable instructions,
wherein the one or more computer-executable instructions are stored in the memory and configured to be executed by the processor, and
the one or more computer-executable instructions are configured to implement the interaction method according to claim 1.

67. A storage medium, configured to store non-transitory computer-executable instructions, wherein the non-transitory computer-executable instructions, when executed by a processor, cause the processor to implement the interaction method according to claim 1.
